(19) United States
(12) Patent Application Publication
(10) Pub. No.: US 2009/0080319 A1
(43) Pub. Date: Mar. 26, 2009

(54) OBJECTIVE OPTICAL SYSTEM AND OPTICAL INFORMATION RECORDING/REPRODUCING DEVICE HAVING THE SAME

(75) Inventors: Daisuke KOREEDA, Saitama (JP); Shuichi TAKEUCHI, Saitama (JP); Yoshiyuki TASHIRO, Kanagawa (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/233,048

(22) Filed: Sep. 18, 2008

(30) Foreign Application Priority Data
Sep. 20, 2007 (JP) 2007-243467

(51) Int. Cl. G11B 7/00

(52) U.S. Cl. 369/112.23; 369/100; G9B/7

(57) ABSTRACT

There is provided an objective optical system including an optical element having a phase shift structure, and a single-element objective lens made of resin, wherein the phase shift structure includes a plurality of refractive surface zones, the phase shift structure includes a first area to contribute to converging at least the third light beam on a record surface of the third optical disc, the first area includes at least two types of steps, each of which is formed at a boundary between adjacent ones of the plurality of refractive surface zones, the at least two types of steps gives optical path length differences different from each other to an incident light beam, the annular zone structure satisfies following conditions:

0.01<(EP21−EP11)/EP11<0.10

0.04<(EP31−EP11)/EP11<0.30

−100<Σ(ΔOPD11/λ₁)+Σ(ΔOPD12/λ₁)<−10

where EP11=INT((ΔOPD11/λ₁)+0.5)×(λ₁(n1−1)),

EP21=INT((ΔOPD21/λ₂)+0.5)×(λ₂(n1−1)),

EP31=INT((ΔOPD31/λ₃)+0.5)×(λ₃(n1−1)).

### BACKGROUND OF THE INVENTION

The present invention relates to an objective optical system which is installed in a device employing multiple types of light beams having different wavelengths, such as an optical information recording/reproducing device for recording information to and/or reproducing information from multiple types of optical discs differing in recording density.

There exist various standards of optical discs (CD, DVD, etc.) differing in recording density, protective layer thickness, etc. Meanwhile, new-standard optical discs (HD DVD (High-Definition DVD), BD (Blu-ray Disc), etc.), having still higher recording density than DVD, are being brought into practical use in recent years to realize still higher information storage capacity. The protective layer thickness of such a new-standard optical disc is substantially equal to or less than that of DVD. In consideration of user convenience with such optical discs according to multiple standards, the optical information recording/reproducing devices (more specifically, objective optical systems installed in the devices) of recent years are required to have compatibility with the above three types of optical discs. Incidentally, in this specification, the “optical information recording/reproducing devices” include devices for both information reproducing and information recording, devices exclusively for information reproducing, and devices exclusively for information recording. The above “compatibility” means that the optical information recording/reproducing device ensures the information reproducing and/or information recording with no need of component replacement even when the optical disc being used is switched.

In order to provide an optical information recording/reproducing device having the compatibility with optical discs of multiple standards, the device has to be configured to be capable of forming a beam spot suitable for a particular recording density of an optical disc being used, by changing a NA (Numerical Aperture) of an objective optical system used for information reproducing/registering, while also correcting spherical aberration which varies depending on the protective layer thickness changed by switching between optical discs of different standards. Since the diameter of the beam spot can generally be made smaller as the wavelength of the beam gets shorter, multiple laser beams having different wavelengths are selectively used by the optical information recording/reproducing device depending on the recording density of the optical disc being used. For example, for CDs, a laser beam with a wavelength of approximately 790 nm (a so-called near-infrared laser) is used. For DVDs, a laser beam with a wavelength of approximately 660 nm (a so-called red laser) shorter than the wavelength for CDs is used. For the aforementioned new-standard optical discs, a laser beam with a wavelength still shorter than that for DVDs (e.g., so-called “blue laser” around 408 nm) is used in order to deal with the extra-high recording density.

Examples of an optical system for suitably converging the laser beams on the three types of optical discs, respectively, are disclosed in Japanese Patent Provisional Publications Nos. 2006-164498A (hereafter, referred to as JP2006-164498A), 2006-12394A (hereafter, referred to as JP2006-12394A), 2007-122828A (hereafter, referred to as JP2007-122828A) and 2005-158217A (hereafter, referred to as JP2005-158217A).

An objective optical system disclosed in Japanese Patent Provisional Publication No. 2006-164498A (hereafter, referred to as JP2006-164498A) is configured such that at least one surface of an objective lens or an at least one surface of an optical element located on the front side of the objective lens is provided with a diffraction surface. The diffraction surface is configured such that the diffraction order at which the diffraction efficiency for the blue laser beam is maximized is an even order. Each of the blue laser and the red laser is incident on the objective optical system as a collimated beam, and the near-infrared laser beam is incident on the objective optical system as a non-collimated beam (a diverging beam). As described above, the objective optical system disclosed in JP2006-164498A has the compatibility with the plurality of types of optical discs of different standards by appropriately selecting the diffraction effect and the degree of divergence for each of the plurality of types of optical discs.

An objective optical system disclosed in JP2006-12394A is configured to have an optical element (or an objective lens) formed by cementing two types of optical components made of different materials with respect to each other. A diffraction structure is formed on a cementing surface between the two types of components. The objective optical system is designed so that, through use of the difference between the refractive indexes of the two types of optical components and the diffraction effect; the optical element can enhance the use efficiency for each of the different types of laser beams.

In an optical system disclosed in JP2007-122828A, substantially the same optical configuration as that disclosed in JP2006-12394A is employed to maintain the diffraction efficiency at a high level for each of the blue laser and the near-infrared laser. More specifically, JP2007-122828A discloses an optical pick-up device configured to have a diffraction grating formed by laminating at least two types of elements having different degrees of dispersion together so that high diffraction efficiency can be maintained for both of the blue laser and the infrared laser. JP2007-122828A also discloses an optical pick-up device provided with an optical element having a single diffraction surface designed to appropriately select, for each of the blue laser and the near-infrared laser, the diffraction order at which the diffraction efficiency is maximized.

JP2005-158217A discloses an objective optical system for an optical pick-up provided with a diffraction optical element located on the front side of the objective lens. More specifically, the diffraction optical element includes a diffraction surface which has no diffraction effect on the blue laser and the near-infrared laser but has diffraction effect on the red laser, and a diffraction surface which has no diffraction effect on the blue laser and the red laser but has diffraction effect on the near-infrared laser. By thus employing the diffraction optical element having two diffraction surfaces with different diffraction effects, the optical pick-up achieves the compatibility with the different types of optical discs.

However, the optical configurations disclosed in JP2006-164498A, JP2006-12394A, JP2007-122828A and JP2005-158217A have the following drawbacks.

Since the diffraction structure of the objective optical system disclosed in JP2006-164498A is configured such that the diffraction order at which the diffraction efficiency for the blue laser is maximized is an even order, it is necessary to use a non-collimated beam for at least one of the plurality of types of laser beams. If a non-collimated beam is used, off-axis aberration, such as a soma, is inevitably caused when the objective lens shifts in a plane perpendicular to an optical axis of the objective lens, fox example, during a tracking operation.

In manufacturing the objective optical system disclosed in JP2006-12394A, the manufacturing process increases for a cementing process. In addition, it is necessary to appropriately from the diffraction structure on the cementing surface. Therefore, the manufacturing of the objective optical system requires considerably high accuracy, which increases the manufacturing cost.

Since the optical system disclosed in JP2007-122828A uses the diffraction grating, the manufacturing of the optical system requires the considerably high accuracy, and the manufacturing cost is increased. The diffraction surface of the optical element disclosed in JP2007-122828A is configured to produce the intense diffraction light of an even order for the blue laser. In this case, it is difficult to correct the relative spherical aberration caused by switching between an optical disc requiring the blue laser and an optical disc requiring the near-infrared laser.

Since the diffraction optical element disclosed in JP2005-158217A does not have the diffraction effect on the blue laser, it is impossible to control the spherical aberration caused by the wavelength variations and the temperature variations. In particular, if resin is used as material of the objective lens, the spherical aberration caused due to the temperature variations becomes considerably large. Therefore, in this case, a spherical aberration correction element (e.g., a liquid crystal element) having a complicated structure is required.

### SUMMARY OF THE INVENTION

The present invention is advantageous in that it provides at least one of an objective optical system and an optical information recording/reproducing device configured to have compatibility with multiple types of optical discs of different standards, to maintain the use efficiency of light for optical discs (e.g., BD) having high recording densities at a high level while increasing the use efficiency of light for other optical discs having relatively low recording densities, and to be manufactured easily at a low cost.

According to an aspect of the invention, there is provided an objective optical system used for an optical information recording/reproducing device for recording information to and/or reproducing information from at least three types of optical discs, by selectively using one of three types of substantially collimated light beams including a first light beam having a first wavelength λ₁ (nm), a second light beam having a second wavelength λ₂ (nm) and a third light beam having a third wavelength λ₃ (nm), The at least three types of optical discs includes a first optical disc for which information recording or information reproducing is executed by using the first light beam, a second optical disc for which information recording or information reproducing is executed by using the second light beam, and a third optical disc for which information recording or information reproducing is executed by using the third light beam. The first, second and third wavelengths λ₁, λ₂ and λ₃ satisfies a condition λ₁<λ₂<λ₃. When protective layer thicknesses of the first, second and third optical discs are represented by t1 (mm), t2 (mm) and t3 (mm), respectively, the protective layer thicknesses satisfy a condition of t1<t2<t3. When numerical apertures required for information reproducing or information recording on the first, second and third optical discs are defined as NA1, NA2 and NA3, respectively, the numerical apertures satisfy following relationships: (NA1>NA3); and (NA2>NA3).

In this configuration, the objective optical system includes an optical element configured to have a phase shift structure on at least one surface of the optical element; and a single-element objective lens made of resin located between the optical element and an optical disc being used. The phase shift structure includes a plurality of refractive surface zones concentrically formed about a predetermined axis. The phase shift structure includes a first area to contribute to converging at least the third light beam on a record surface of the third optical disc. The first area includes at least two types of steps, each of which is formed at a boundary between adjacent ones of the plurality of refractive surface zones. The at least two types of steps gives optical path length differences different from each other to an incident light beam.

When m11 represents a diffraction order at which diffraction efficiency for the first light beam given by a first step of the at least two types of steps in the first area is maximized, m21 represents a diffraction order at which diffraction efficiency for the second light beam given by the first step is maximized, m31 represents a diffraction order at which diffraction efficiency for the third light beam given by the first step is maximized, m12 represents a diffraction order at which diffraction efficiency for the first light beam given by a second step of the at least two types of steps in the first area is maximized, n1 represents a refractive index of the optical element with respect to the first light beam, n2 represents a refractive index of the optical element with respect to the second light beam, and n3 represents a refractive index of the optical element with respect to the third light beam, the phase shift structure satisfies following conditions:

0.01<(E21−E11)/E11<0.10 (2);

0.04<(E31−E11)/E11<0.30 (3); and

−100<φ1+φ2<−10 (4),

where E11=m11(λ₁/(n1−1)),

E21=m21(λ₂/(n2−1)),

E31=m31(λ₃/(n3−1)),

φ1=ΣP₁2ih²ⁱ×m11 (unit: λ₁),

φ2=ΣP₂2ih²ⁱ×m12 (unit: λ₁),

P₁2i (i: natural number) represents a 2i-order coefficient of an optical path difference function defining the first step, and P₂2i represents a 2i-order coefficient of an optical path difference function defining the second step.

Such a configuration makes it possible to achieve relatively high use efficiency of light for each of the light beams while suppressing the spherical aberration for information recording or information reproducing of each of the three types of optical discs.

In at least one aspect, the phase shift structure satisfies conditions:

0.015<(E21−E11)/E11<0.055 (5); and

−75<φ1+φ2<−35 (6).

In at least one aspect, the optical element is configured such that, with regard to the first light beam, a refracting effect is cancelled by an effect of giving an optical path length difference by the phase shift structure so that the optical element has almost no power with respect to the first light beam,

wherein the optical element has Abbe number νd satisfying a condition:

15<νd<40 (1),

wherein the phase shift structure takes values of m11=10, m21=6 and m31=5.

In at least one aspect, the phase shift structure includes three types of steps, each of which is formed at a boundary between adjacent ones of the plurality of refractive surface zones. At least one type of the three types of steps is configured such that a diffraction order at which diffraction efficiency for the first light beam is maximized is a second order, a diffraction order at which diffraction efficiency for the second light beam is maximized is a first order, and a diffraction order at which diffraction efficiency for the third light beam is maximized is a first order.

According to another aspect of the invention, there is provided an objective optical system used for an optical information recording/reproducing device for recording information to and/or reproducing information from at least three types of optical discs, by selectively using one of three types of substantially collimated light beams including a first light beam having a first wavelength λ₁ (nm), a second light beam having a second wavelength λ₂ (nm) and a third light beam having a third wavelength λ₃ (nm). The at least three types of optical discs includes a first optical disc for which information recording or information reproducing is executed by using the first light beam, a second optical disc for which information recording or information reproducing is executed by using the second light beam, and a third optical disc for which information recording or information reproducing is executed by using the third light beam. The first, second and third wavelengths λ₁, λ₂ and λ₃ satisfies a condition λ₁<λ₂<λ₃. When protective layer thicknesses of the first, second and third optical discs are represented by t1 (mm), t2 (mm) and t3 (mm), respectively, the protective layer thicknesses satisfy a condition of t1<t2<t3. When numerical apertures required for information reproducing or information recording on the first, second and third optical discs are defined as NA1, NA2 and NA3, respectively, the numerical apertures satisfy following relationships: (NA1>NA3); and (NA2>NA3).

In this configuration, The objective optical system includes an optical element configured to have a phase shift structure on at least one surface of the optical element, and a single-element objective lens made of resin located between the optical element and an optical disc being used. The phase shift structure includes a plurality of refractive surface zones concentrically formed about a predetermined axis. The phase shift structure includes a first area to contribute to converging at least the third light beam on a record surface of the third optical disc. The first area includes at least two types of steps, each of which is formed at a boundary between adjacent ones of the plurality of refractive surface zones. The at least two types of steps gives optical path length differences different from each other to an incident light beam. The annular zone structure satisfies following conditions:

0.01<(EP21−EP11)/EP11<0.10 (7);

0.04<(EP31−EP11)/EP11<0.30 (8); and

−100<Σ(ΔOPD11/λ₁)+Σ(ΔOPD12/λ₁)<−10 (9),

where EP11=INT((ΔOPD11/λ₁)+0.5)×(λ₁(n1−1)),

EP21=INT((ΔOPD21/λ₂)+0.5)×(λ₂(n1−1)),

EP31=INT((ΔOPD31/λ₃)+0.5)×(λ₃(n3−1)),

ΔOPD11/λ₁, denotes an optical path length difference given by a first step of the at least two types of steps in the first area to the first light beam, ΔOPD21/λ₂ denotes an optical path length difference given by the first step to the second light beam, and ΔOPD31/λ₃ denotes an optical path length difference given by the first step to the third light beam, and ΔOPD12/λ₁ denotes an optical path length difference given by a second step of the at least two types of steps to the first light beam, n1 represents a refractive index of the optical element with respect to the first light beam, n2 represents a refractive index of the optical element with respect to the second light beam, and n3 represents a refractive index of the optical element with respect to the third light beam.

Such a configuration makes it possible to achieve relatively high use efficiency of light for each of the light beams while suppressing the spherical aberration for information recording or information reproducing of each of the three types of optical discs.

In at least one aspect, the phase shift structure satisfies conditions:

0.015<(EP21−EP11)/EP11<0.055 (10); and

−75<Σ(ΔOPD11/λ₁)+Σ(ΔOPD12/λ₁)<−35 (11).

In at least one aspect, the optical element is configured such that, with regard to the first light beam, a refracting effect is cancelled by an effect of giving an optical path length difference by the phase shift structure so that the optical element has almost no power with respect to the first light beam. The optical element has Abbe number νd satisfying a condition:

15<νd<40 (1).

Further, one of the at least two types of steps satisfies a condition:

9.85<|ΔOPD11/λ₁|<10.35 (12).

In at least one aspect, the phase shift structure includes three types of steps giving optical path length differences to an incident beam, each of the three types of steps being formed at a boundary between adjacent ones of the plurality of refractive surface zones. At least one type of the three types of steps gives an optical path length difference approximately equal to 2λ₁ to the first light beam.

With regard to the above described two aspects of the invention concerning the objective optical system, the phase shift structure may include a second area located outside the first area. In this case, the second area is configured to contribute to converging the first and second light beams on record surfaces of the first and second optical discs, respectively, and not to contribute to convergence of the third light beam. The second area includes a step formed at a boundary between adjacent ones of the plurality of refractive surface zones, the step in the second area giving at least one type of optical path length difference to an incident light beam. An absolute value of the at least one type of optical path length difference given by the step in the second area is approximately equal to an odd multiple of the first wavelength of the first light beam.

In at least one aspect, the absolute value of the at least one type of optical path length difference given by the step in the second area is approximately equal to 3λ₁.

In at least one aspect, the absolute value of the at least one type of optical path length difference given by the step in the second area is approximately equal to 5λ₁.

In at least one aspect, the phase shift structure includes a third area located outside the second area. In this case, the third area is configured to contribute to converging the first light beam on the record surface of the first optical disc, and not to contribute to convergence of each of the second and third light beams. The third area includes a step formed at a boundary between adjacent ones of the plurality of refractive surface zones, the step in the third area giving at least one type of optical path length difference to an incident light beam. An absolute value of the at least one type of optical path length difference given by the step in the third area is different from absolute values of all types of optical path length differences given by the second area.

In at least one aspect, the objective optical system according to claim 16, wherein the at least one type of optical path length difference given by the step in the third area is approximately equal to 1λ₁.

According to another aspect of the invention, there is provided an optical information recording/reproducing device for recording information to and/or reproducing information from at least three types of optical discs. The optical information recording/reproducing device includes light sources respectively emitting the first to third light beams, conversion optical components respectively converging the first to third light beams into collimated light beams, and the above mentioned objective optical system. In this configuration the protective layer thicknesses of the first to third optical discs are defined as t3−t1≧1.0 mm, and t2≈0.6 mm.

### BRIEF DESCRIPTION OF THE ACCOMPANYING DRAWINGS

FIG. 1 illustrates a general configuration of an optical information recording/reproducing device on which an objective optical system is mounted.

FIG. 2 is an optical block diagram of an objective optical system according to a first example.

FIG. 3 is an optical block diagram of an objective optical system according to a second example.

FIG. 4 is an optical block diagram of an objective optical system according to a third example.

FIG. 5 is an optical block diagram of an objective optical system according to a fourth example.

FIGS. 6A-6C show the spherical aberration caused in the objective optical system according to the first example.

FIGS. 7A-7C show the spherical aberration caused in the objective optical system according to the first example.

FIGS. 8A-8C show the spherical aberration caused in the objective optical system according to the first example.

FIGS. 9A-9C show the spherical aberration caused in the objective optical system according to the first example.

FIG. 10A is a front view illustrating a annular zone structure formed on a first surface of an optical element, and FIG. 10B is a cross sectional view of the optical element illustrating the annular zone structure formed thereon.

### DETAILED DESCRIPTION OF THE EMBODIMENTS

Hereinafter, an embodiment according to the invention are described with reference to the accompanying drawings.

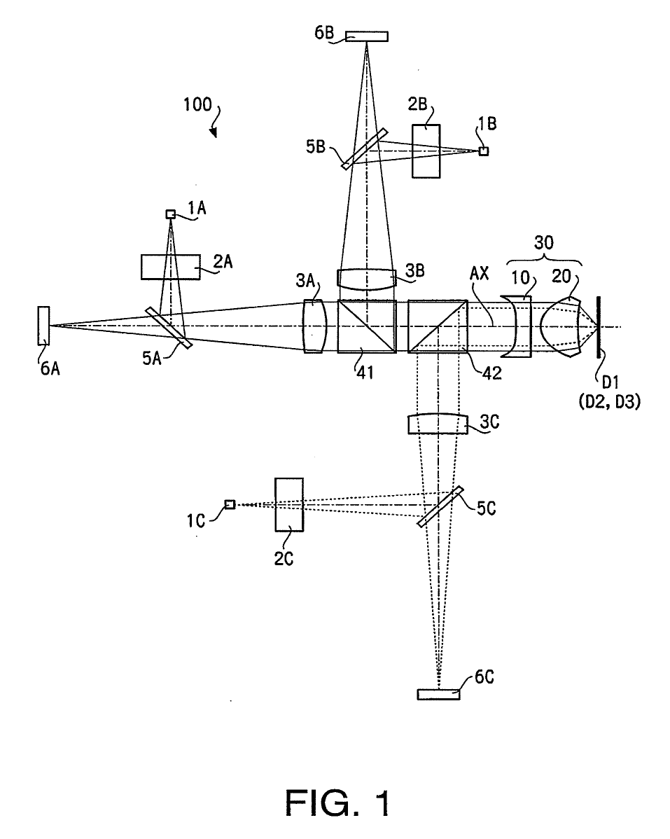

In the following, an objective optical system 30 according to the embodiment, and an optical information recording/reproducing device 100 on which the objective optical system 30 is mounted are described (see FIG. 1).

In the following explanation, an optical disc of a type (one of the three types) having the highest recording density (e.g. a new-standard optical disc such as BD) will be referred to as an “optical disc D1”, an optical disc of a type having a relatively low recording density compared to the optical disc D1 (DVD, DVD-R, etc.) will be referred to as an “optical disc D2”, and an optical disc of a type having the lowest recording density (CD, CD-R, etc.) will be referred to as an “optical disc D3” for convenience of explanation.

If the protective layer thicknesses of the optical discs D1-D3 are defined as t1, t2, t3, respectively, the protective layer thicknesses satisfies the following relationship.

t1<t2<t3

In order to carry out the information reproducing/recording on each of the optical discs D1-D3, the NA (Numerical Aperture) required for the information reproducing/recording has to be varied properly so that a beam spot suitable for the particular recording density of each optical disc can be formed. When the optimum design numerical apertures required for the information reproducing/recording on the three types of optical discs D1, D2 and D3 are defined as NA1, NA2 and NA3, respectively, the numerical apertures (NA1, NA2, NA3) satisfy the following relationships.

(NA1>NA3) and (NA2>NA3)

Specifically, for the information recording/reproducing on the optical discs D1 and D2 having high recording densities, a relatively large NA is required since a relatively small beam spot has to be formed. On the other hand, for the information recording/reproducing on the optical disc D3 having the lowest recording density, the required NA is relatively small. Incidentally, each optical disc is set on a turntable (not shown) and rotated at high speed when the information recording/reproducing is carried out.

In cases where three types of optical discs D1-D3 (having different recording densities) are used as above, multiple laser beams having different wavelengths are selectively used by the optical information recording/reproducing device so that a beam spot suitable for each recording density can be formed on the record surface of the optical disc being used.

Specifically, for the information recording/reproducing on the optical disc D1, a “first laser beam” having the shortest wavelength is emitted from a light source so as to form the smallest beam spot on the record surface of the optical disc D1. On the other hand, for the information recording/reproducing on the optical disc D3, a “third laser beam” having the longest wavelength is emitted from a light source so as to form the largest beam spot on the record surface of the optical disc D3. For the information recording/reproducing on the optical disc D2, a “second laser beam” having a wavelength longer than that of the first laser beam and shorter than that of the third laser beam is emitted from a light source so as to form a relatively small beam spot on the record surface of the optical disc D2.

If the wavelengths of the first, second and third laser beams are defined as λ₁, λ₂ and λ₃, respectively, the wavelengths satisfy the following relationship.

λ₁<λ₂<λ₃

FIG. 1 illustrates a general configuration of the optical information recording/reproducing device 100 on which the objective optical system 30 is mounted. As shown in FIG. 1, the optical information recording/reproducing device 100 includes a light source 1A which emits the first laser beam, a light source 1B which emits the second laser beam, a light source 1C which emits the third laser beam, diffraction gratings 2A, 2B and 2C, coupling lenses 3A, 3B and 3C, beam splitters 41 and 42, half mirrors 5A, 5B and 5C, photoreceptors 6A, 6B and 6C, and the objective optical system 30.

In FIG. 1, a reference axis AX of the optical information recording/reproducing device 100 is indicated by a chain line. In a normal state, an optical axis of the objective optical system 30 coincides with the reference axis AX of the optical information recording/reproducing device 100. However, the optical axis of the objective optical system 30 or an optical axis of an objective lens 20 may be shifted from the reference axis AX for a tracking operation.

As described above, the required NA varies depending on the type of the optical disc being used. Therefore, the optical information recording/reproducing device 100 may be provided with one or more aperture stops for adjusting beam diameters of the first to third laser beams.

Each optical disc has the protective layer and the record surface (not shown). Practically, the record surface is sandwiched between the protective layer and a substrate layer or a label layer.

As shown in FIG. 1, the first, second and third laser beams emitted by the light sources 1A, 1B and 1C are directed to a common optical path after passing through the diffraction gratings 2A, 2B, and 2C, the coupling lenses 3A, 3B and 3C, and the beam splitters 41 and 42. Then, each of the first, second and third laser beams enters the objective optical system 30. The first, second and third laser beams emitted by the light sources 1A, 1B and 1C are converted into collimated beams by the coupling lenses 3A, 3B and 3C, respectively. That is, in this embodiment, each of the coupling lenses 3A, 3B and 3C functions as a collimator lens. Therefore, each of the first, second and third laser beams enters the objective optical system 30 as a collimated beam.

By thus configuring the optical information recording/reproducing device 100, it is possible to suitably suppress off-axis aberrations, such as a coma, even if the objective optical system 30 (i.e., the objective lens 20) shifts by a minute distance in a direction perpendicular to the optical axis of the objective optical system 30 for the tracking operation.

Each of the first, second and third laser beams passed through the objective optical system 30 converges onto the record surface of the corresponding optical disc. The laser beam reflected from the record surface of each of the optical discs D1, D2 and D3 returns toward the objective optical system 30 along the same optical path, and thereafter passes through the corresponding one of the half mirror 5A, 5B and 5C before finally detected by the corresponding one of the photoreceptors 6A, 6B and 6C.

Since the first to third laser beams having different wavelengths are used for the optical discs D1-D3 in the optical information recording/reproducing device 100, the spherical aberration varies depending on change of the refractive index of the objective lens 10 and the difference in protective layer thicknesses between the optical discs D1-D3. In order to provide the compatibility with the three types of optical discs D1-D3 for the optical information recording/reproducing device 100, it is necessary to suitably correct the spherical aberration for each of the optical discs D1-D3. In order to perform the information recording/reproducing, for each of the optical discs D1-D3, in a high degree of accuracy while keeping a high S/N level, it is necessary to increase the use efficiency of light and thereby to use a sufficient amount of light to form a beam spot having a predetermined diameter on the record surface of the optical disc being used. For this reason, the objective optical system 30 according to the embodiment is configured as follows.

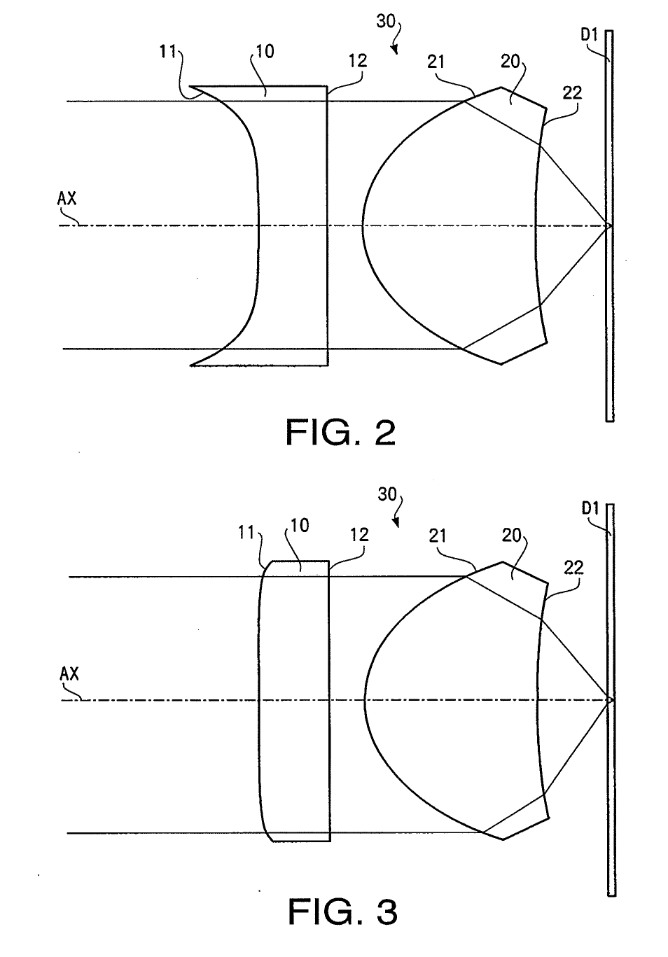

As shown in FIG. 1, the objective optical system 30 includes an optical element 10 and the objective lens 20 arranged, along the optical path, in this order from the light source side. FIG. 2 is an enlarged view of the objective optical system 30. It should be noted that, although in FIG. 2 the optical disc D1 is illustrated as an optical disc being used, the objective optical system 30 provides the same configuration as that shown in FIG. 2 for each of the optical discs D2 and D3.

As shown in FIG. 2, the optical element 10 has a first surface 11 and a second surface 12 arranged in this order from the light source side. The objective lens 20 has a first surface 21 and a second surface 22 arranged in this order from the light source side. The objective lens 20 is a biconvex single-element lens.

Each of the first surface 11 of the optical element 10 and the first and second surfaces 21 and 22 of the objective lens 20 is an aspherical surface.

A shape of an aspherical surface is expressed by a following equation:

$$X ( h ) = \frac{{ch}^{2}}{1 + \sqrt{1 - ( 1 + K ) {c}^{2} {h}^{2}}} + {\sum }_{i = 2}^{ } {A}_{2 i} {h}^{2 i}$$

where, X(h) represents a SAG amount which is a distance between a point on the aspherical surface at a height of h from the optical axis and a plane tangential to the aspherical surface at the optical axis, symbol c represents curvature (l/r) on the optical axis, K is a conical coefficient, and A₂ᵢ (i: integer) represents an aspherical coefficient of an even order larger than or equal to the fourth order. By thus forming optical surfaces of the optical components of the objective optical system 30 to be aspherical surfaces, it becomes possible to suitably correct the spherical aberration.

The optical element 10 is made of a single material. In order to secure easiness and effectiveness in manufacturing, the optical element 20 is made of resin. The material having the Abbe number νd satisfying a following condition (1) is used as material of the optical element 10.

15<νd<40 (1)

As described above, the optical element 20 is made of material having a relatively low Abbe number (i.e., material having a high degree of dispersion). In addition, the optical element 10 is provided with an annular zone structure. By this configuration, the objective optical system enhances the use efficiency of light for all of the first to third laser beams.

In general, a designer of an objective optical system for an optical information recording/reproducing device tends to avoid use of material having a high degree of dispersion because material having a high degree of dispersion causes a relatively large amount of chromatic aberration. By contrast, according to the embodiment, the optical element 10 is configured such that, with regard to the first laser beam, the refracting effect is cancelled by the effect of giving the optical path length difference by the annular zone structure. In other words, the optical element 10 has almost no power with respect to the first laser beam. Consequently, the amount of chromatic aberration can be suppressed.

Such a configuration of the optical element 10 also makes it possible to effectively suppress the aberrations caused when the positional relationship between the optical element 10 and the objective 20 changes.

Hereafter, the annular zone structure formed on the optical element 10 is explained in detail. In this embodiment, at least one of first and second surfaces 11 and 12 of the optical element 10 is provided with the annular zone structure. The annular zone structure has a plurality of refractive surface zones (annular zones) concentrically formed about the reference axis AX. The plurality of annular zones are divided by minute steps formed between adjacent ones of the plurality of annular zones to extend in parallel with the optical axis of the optical element 10.

Each step is designed such that a predetermined optical path length difference is caused between a laser beam passing through the inside of the boundary and a laser beam passing through the outside of the boundary. It is noted that such an annular zone structure may be called a diffraction structure.

If the annular zone structure is designed such that the predetermined optical path length difference is a n-fold value (n: integer) of a particular wavelength α, the annular zone structure may be expressed as an n-th order diffraction structure having the blazed wavelength α. If a laser beam having a particular wavelength β passes through the diffraction structure, the diffraction order having the highest diffraction efficiency is equal to an integer “m” closest to a value obtained by dividing the optical path length difference with the wavelength β.

Considering the fact that a predetermined optical path length difference is caused between the laser beam passing through the inside of a boundary and the laser beam passing through the outside of the boundary, the effect of the step can be regarded as shifting the phases of the laser beam passing through the inside of a boundary and the laser beam passing through the outside of the boundary with respect to each other. In other words, the annular zone structure can be pressed as a structure for phase-shifting an incident beam (i.e., a phase-shift structure).

If the annular zone structure is considered as the diffraction structure, the annular zone structure can be expressed by a following optical path difference function φ(h). The optical path difference function φ(h) represents the function as a diffraction lens in a form of an additional optical path length at a height h from the optical axis. That is, the optical path difference function φ(h) is a function which defines the position and height of each step in the annular zone structure (i.e., the diffraction structure).

More specifically, the optical path difference function φ(h) can be expressed by an equation:

$$φ ( h ) = m λ {\sum }_{i = 1}^{ } {P}_{2 i} {h}^{2 i}$$

where P₂ᵢ represents the 2i-th order coefficient (i: natural number), h represents a height from the optical axis, m represents a diffraction order at which the diffraction efficiency of the laser beam being used is maximized, and λ represents a design wavelength of the laser beam being used.

The annular zone structure provided on the optical element 10 is defined not only by using a single optical path difference function but also by combining a plurality of types of optical path difference functions. In this embodiment, the annular zone structure includes two or more types of steps giving different optical path length differences to the incident beam. The two or more types of steps are obtained by combining the plurality of types of optical path difference functions. By this structure, it is possible to give a plurality of types of optical effects to the incident beam.

In the following explanation, m11 represents the diffraction order at which the diffraction efficiency for the first laser beam given by one of the two or more steps (hereafter, referred to as a first step) is maximized, m21 represents the diffraction order at which the diffraction efficiency for the second laser beam given by the first step is maximized, m31 represents the diffraction order at which the diffraction efficiency for the third laser beam given by the first step is maximized, m12 represents the diffraction order at which the diffraction efficiency for the first laser beam given by another step of the two or more types of steps (hereafter, referred to as a second step) giving an optical path length difference different from the optical path length difference given by the first step is maximized, m22 represents the diffraction order at which the diffraction efficiency for the second laser beam given by the second step is maximized, m32 represents the diffraction order at which the diffraction efficiency for the third laser beam given by the second step is maximized, n1 represents the refractive index of the optical element 10 with respect to the first laser beam, n2 represents the refractive index of the optical element 10 with respect to the second laser beam, and n3 represents the refractive index of the optical element 10 with respect to the third laser beam.

The annular zone structure is configured such that the two or more types of steps satisfy the following conditions (2), (3) and (4):

0.01<(E21−E11)/E11<0.10 (2)

0.04<(E31−E11)/E11<0.30 (3)

−100<φ1+φ2<−10 (4)

where E11=m11(λ₁/(n1−1)),

E21=m21(λ₂/(n2−1)),

E31=m31(λ₃/(n3−1)),

φ1=ΣP₁2ih²ⁱ×m11 (unit: λ₁),

φ2=ΣP₂2ih²ⁱ×m12 (unit: λ₁),

P₁2i (i: integer) represents a 2i order coefficient of an optical path difference function defining the first step, and P₂2i represents a 2i order coefficient of an optical path difference function defining the second step. That is, φ1 represents an additional optical path length (unit: λ₁) given by the first step in the effective radius of a first area defined on the optical element 10 as an area for converging the third laser beam on the record surface of the optical disc D3, and φ2 represents an additional optical path length (unit: λ₁) given by the second step in the effective radius of the first area.

E11 represents the amplitude of the diffraction effect given by the annular zone structure to the first laser beam, E21 represents the amplitude of the diffraction effect given by the annular zone structure to the second laser beam, and E31 represents the amplitude of the diffraction effect given by the annular zone structure to the third laser beam. In this case, the diffraction effect relates particularly to the effect of correcting the spherical aberration.

Each of the conditions (2) and (3) defines the diffraction effect of the first step. The condition (2) means that the diffraction effect on the second laser beam is larger than the diffraction effect on the first laser beam. The condition (3) means that the diffraction effect on the third laser beam is larger than the diffraction effect on the first laser beam.

The objective optical system 30 satisfying the conditions (2) and (3) is able to suitable correct the spherical aberration for each of the first to third laser beams.

If (E21−E11)/E11 gets larger than or equal to the upper limit of the condition (2), the spherical aberration becomes a overcorrected condition particularly when the optical disc D2 is used; If (E21−E11)/E11 gets smaller than or equal to the lower limit of the condition (2), the spherical aberration becomes an undercorrected condition particularly when the optical disc D2 is used.

If (E31−E11)/E11 gets larger than or equal to the upper limit of the condition (3), the spherical aberration becomes a overcorrected condition particularly when the optical disc D3 is used. If (E31−E11)/E11 gets smaller than or equal to the lower limit of the condition (3), the spherical aberration becomes an undercorrected condition particularly when the optical disc D3 is used.

The condition (4) relates a sum of additional optical path lengths given by the first and second steps. By satisfying the condition (4), the relative spherical aberration caused when the optical disc being used is switched between optical discs of different standards can be suppressed more suitably. Further, it is possible to correct the spherical aberration caused when the wavelength of the laser beam being used varies by a minute amount. If (φ1+φ2) gets smaller than or equal to the lower limit of the condition (4), the spherical aberration is brought to an overcorrected condition when wavelength variations occur. If (φ1+φ2) gets larger than or equal to the upper limit of the condition (4), the spherical aberration is brought to an undercorrected condition when wavelength variations occur.

If (φ1+φ2) gets larger than or equal to the upper limit of the condition (4), the spherical aberration becomes an overcorrected condition particularly when the optical disc D2 is used. If (φ1+φ2) gets smaller than or equal to the lower limit of the condition (4), the spherical aberration becomes an undercorrected condition particularly when the optical disc D2 is used.

The objective optical system 30 may be configured to further satisfy the following conditions (5) and (6).

0.015<(E21−E11)/E11<0.055 (5)

−75<φ1+φ2<−35 (6)

By satisfying the condition (5) and (6), it becomes possible to achieve the compatibility with the three types of optical discs D1 to D3 in a higher degree of accuracy while decreasing change of the spherical aberration caused when the wavelength of the laser beam used for information recording or information reproducing varies in an minute amount and change of the spherical aberration caused when the objective lens made of resin is used.

Regarding the above described conditions (2), (3) and (4), it is possible to express that the annular zone structure satisfies the following conditions (7), (8) and (9):

0.01<(EP21−EP11)/EP11<0.10 (7);

0.04<(EP31−EP11)/EP11<0.30 (8); and

−100<Σ(ΔOPD11/λ₁)+Σ(ΔOPD12/λ₁)<−10 (9),

where EP11=INT((ΔOPD11/λ₁)+0.5)×(λ₁(n1−1)),

EP21=INT((ΔOPD21/λ₂)+0.5)×(λ₂(n1−1)),

EP31=INT((ΔOPD31/λ₃)+0.5)×(λ₃(n3−1)),

In the above conditions, ΔOPD11/λ₁ denotes an optical path length difference given by the first step to the first laser beam, ΔOPD21/λ₂ denotes an optical path length difference given by the first step to the second laser beam, and ΔOPD31/λ₃ denotes an optical path length difference given by the first step to the third laser beam, and ΔOPD12/λ₁ denotes an optical path length difference given by the second step to the first laser beam,

The conditions (7), (8) and (9) correspond to the conditions (2), (3) and (4), respectively. Therefore, If (EP21−EP11)/EP11 gets larger than or equal to the upper limit of the condition (7), the spherical aberration becomes an overcorrected condition particularly when the optical disc D2 is used. If (EP21−EP11)/EP11 gets smaller than or equal to the lower limit of the condition (7), the spherical aberration becomes an undercorrected condition particularly when the optical disc D2 is used. If (EP31−EP11)/EP11 gets larger than or equal to the upper limit of the condition (8), the spherical aberration becomes an overcorrected condition particularly when the optical disc D3 is used. If (EP31−EP11)/E11 gets smaller than or equal to the lower limit of the condition (8), the spherical aberration becomes an undercorrected condition particularly when the optical disc D3 is used. If (Σ(ΔOPD11/λ₁)+Σ(ΔOPD12/λ₁)) gets smaller than the lower limit of the condition (9), the spherical aberration is brought to an overcorrected condition when wavelength variations occur. If (Σ(ΔOPD11/λ₁)+Σ(ΔOPD12/λ₁)) gets larger than the upper limit of the condition (9), the spherical aberration is brought to an undercorrected condition when wavelength variations occur.

When the conditions (2), (3) and (4) are respectively expressed by the conditions (7), (8), and (9), the conditions (5) and (6) can also be respectively expressed by the following conditions (10) and (11).

0.015<(EP21−EP11)/EP11<0.055 (10)

−75<Σ(ΔOPD11/λ₁)+Σ(ΔOPD12/λ₁)<−35 (11)

One of the two or more types of steps in the annular zone structure is configured such that the optical path length difference ΔOPD11 given to the first laser beam satisfies the following condition (12).

9.85<|ΔOPD11/λ₁|<10.35 (12)

If an optical element not satisfying the condition (12) is used, it becomes impossible to secure a sufficient level of use efficiency of light for the first laser beam. Therefore, such an optical element is not suitable for information recording or information reproducing for the optical D1 with high accuracy.

A design example of the optical element 10 whose material satisfies the condition (1) and which is configured to satisfy the conditions (2) to (12) is m11=10, m21=6 and m31=5.

If the annular zone structure includes three types of steps, the remaining one of the three types of steps (other than the first and the second steps) may be configured such that the diffraction order at which the diffraction efficiency for the first laser beam is maximized is the second order, the diffraction order at which the diffraction efficiency for the second laser beam is maximized is the first order, and the diffraction order at which the diffraction efficiency for the first laser beam is maximized is the first order. By this structure, even if the wavelength of the laser beam being used varies by a minute amount, it is possible to maintain the use efficiency of light at a high level while suppressing the change amount of the spherical aberration to a low level.

If the annular zone structure of the optical element 10 includes three types of steps, the remaining one of the three types of steps (other than the first and second steps) may be designed such that an absolute value of an optical path length difference given to the first laser beam is approximately equal to 2λ₁. By this structure, even if the wavelength of the laser beam being used varies by a minute amount, it is possible to maintain the use efficiency of light at a high level while suppressing the change amount of the spherical aberration to a low level.

By forming the above described annular zone structure within an area (the first area) for converging the third laser beam on the record surface of the optical disc D3 (i.e., an area contributing to convergence of all of the first to third laser beams), a sufficient optical property can be achieved.

It is also possible to form, within a second area located outside the first area, an annular zone structure different from the annular zone structure in the first area. If the second area is provided on the optical element 10, the annular zone structure in the second area is configured to contribute to convergence of each the first and second laser beams on the record surface of the corresponding one of the optical discs D1 and D2, and not to contribute to convergence of the third laser beam on the optical disc D3. That is, the second area functions as an aperture stop for the third laser beam.

The annular zone structure in the second area includes at least a single type of step giving a certain optical path length difference to the incident laser beam. In other words, the annular zone structure in the second area is defined by a single type of optical path difference function or by combination of a plurality of types of optical path difference functions.

To achieve the function as the aperture stop, the annular zone structure in the second area is configured such that the absolute value of the optical path length difference given to the first laser beam by the step in the second area is approximately equal to an odd multiple of the wavelength of the first laser beam.

For example, an annular zone structure including a step giving an optical path length difference, an absolute value of which is approximately equal to 3λ₁ or 5λ₁ to the incident laser beam is formed in the second area. When the third laser beam is incident on such an annular zone structure formed in the second area, the first order diffraction light and the second order diffraction light are produced for the third laser beam. Therefore, the third laser beam passed through the second area does not suitably converge on the record surface of the optical disc D3.

It is also possible to form, within a third area located outside the second area, an annular zone structure different from the annular zone structures in the first and second areas. If the third area is provided on the optical element 10, the annular zone structure in the third area is configured to contribute to convergence of only each the first laser beam on the record surface of the optical disc D1, and not to contribute to convergence of each of the second and third laser beams. That is, the third area is an area provided exclusively for the first laser beam to secure the NA required for information recording or the information reproducing for the optical disc D1 having the highest recording density.

The annular zone structure in the third area includes at least a single type of step giving a certain optical path length difference to the incident laser beam. To provide the third area with a function as an aperture stop with respect to the second and third laser beams, the annular zone structure in the third area is configured such that the absolute value of the optical path length difference given by the annular zone structure in the third area is different from the absolute value of the optical path length difference given by the annular zone structure in the second area. More specifically, at least one type of the plurality of types of optical path difference functions defining the annular zone structure in the third area is not equal to all of the optical path difference functions defining the annular zone structure in the second area.

For example, an annular zone structure giving an optical path length difference, an absolute value of which is approximately equal to λ₁ to the incident laser beam is formed in the third area. By this structure, it is possible to achieve the high diffraction efficiency only for the first laser beam, and to suppress change of the spherical aberration due to minute wavelength variations.

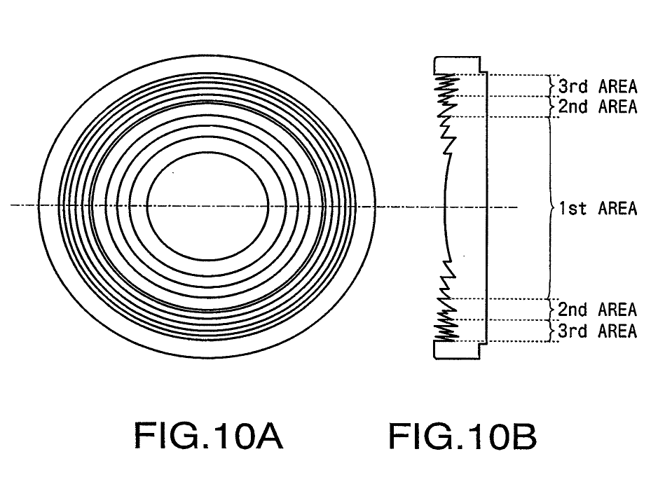

FIGS. 10A and 10B are conceptual illustrations of the annular zone structure formed on the first surface 11 of the optical element 10. FIG. 10A is a front view illustrating the annular zone structure formed on the first surface 11 of the optical element 10, and FIG. 10B is a cross sectional view of the optical element 10 illustrating the annular zone structure formed on the first surface 11 of the optical element 10. In each of FIGS. 10A and 10B, the first to third areas are illustrated.

Hereafter, four numerical examples (first to fourth examples) of the optical information recording/reproducing device 100 are described. In the following examples, the protective layer thicknesses of the optical discs D1-D3 are t1=0.1 mm, t2=0.6 mm and t3=1.2 mm.

### FIRST EXAMPLE

The objective optical system 30 provided in the optical information recording/reproducing device 100 according to a first example is shown in FIG. 2. In the following, the explanation of the configuration of the optical information recording/reproducing device 100 focuses on the numerical configuration of the objective optical system 30 to clarify the features of each example.

The following Table 1 shows concrete specifications of the objective optical system 30 of the objective optical system 100 according to the first example.

TABLE 1

| | 1^{st} laser beam | 2^{nd} laser beam | 3^{rd} laser beam |
|---|---|---|---|
| Wavelength (nm) | 405 | 660 | 790 |
| Focal Length (mm) | 2.50 | 2.59 | 2.61 |
| NA | 0.85 | 0.63 | 0.47 |
| Magnification | 0.000 | 0.000 | 0.000 |

As indicated by the “Magnification” in Table 1, each of the first to third laser beams is incident upon the objective optical system 30 as a collimated beam. With this configuration, it is possible to prevent the off-axis aberration from occurring during the tracking operation.

Table 2 shows a specific numerical configuration defined when the optical disc D1 is used in the optical information recording/reproducing device 100 provided with the objective optical system 30 shown in Table 1. The following Table 3 shows specific numerical configuration defined when the optical disc D2 is used in the optical information recording/reproducing device 100 provided with the objective optical system 30 shown in Table 1. The following Table 4 shows specific numerical configuration defined when the optical disc D3 is used in the optical information recording/reproducing device 100 provided with the objective optical system 30 shown in Table 1.

TABLE 2

| Surface No. | r | d | n (405 nm) | |
|---|---|---|---|---|
| 0 | | ∞ | | Light Source 1A |
| 1 (1^{st} Area) | ∞ | 1.00 | 1.65098 | Optical Element |
| 1 (2^{nd} Area) | ∞ | | | |
| 1 (3^{rd} Area) | ∞ | | | |
| 2 | ∞ | 0.50 | | |
| 3 | 1.800 | 2.50 | 1.71557 | Objective Lens |
| 4 | −122.240 | 0.99 | | |
| 5 | ∞ | 0.10 | 1.62231 | Optical Disc D1 |
| 6 | ∞ | — | | |

TABLE 3

| Surface No. | r | d | n(660 nm) | |
|---|---|---|---|---|
| 0 | | ∞ | | Light Source 1B |
| 1(1^{st} Area) | ∞ | 1.00 | 1.59978 | Optical Element |
| 1(2^{nd} Area) | ∞ | | | |
| 1(3^{rd} Area) | ∞ | | | |
| 2 | ∞ | 0.50 | | |
| 3 | 1.800 | 2.50 | 1.68937 | Objective Lens |
| 4 | −122.240 | 0.74 | | |
| 5 | ∞ | 0.60 | 1.57961 | Optical Disc D2 |
| 6 | ∞ | — | | |

TABLE 4

| Surface No. | r | d | n(790 nm) | |
|---|---|---|---|---|
| 0 | | ∞ | | Light Source 1C |
| 1(1^{st} Area) | ∞ | 1.00 | 1.59073 | Optical Element |
| 1(2^{nd} Area) | ∞ | | | |
| 1(3^{rd} Area) | ∞ | | | |
| 2 | ∞ | 0.50 | | |
| 3 | 1.800 | 2.50 | 1.68436 | Objective Lens |
| 4 | −122.240 | 0.38 | | |
| 5 | ∞ | 1.20 | 1.57307 | Optical Disc D3 |
| 6 | ∞ | — | | |

In the Tables 2-4, the surface #0 represents a light source (1A-1C), the surfaces #1 and #2 represent the first and second surfaces 11 and 12 of the optical element 10, respectively, the surfaces #3 and #4 represent the first and second surfaces 21 and 22 of the objective lens 20, and the surfaces #5 and #6 represent the protective layer and the record surface of the corresponding optical disc.

In Tables 18-20 (and in the following similar Tables), “r” denotes the curvature radius (mm) of each optical surface, and “d” denotes the thickness of an optical component or the distance (mm) from each optical surface to the next optical surface during the information reproduction/recordation.

Each of the first surface 11 (surface #1) of the optical element 10 and the first and second surfaces 21 and 22 (surfaces #3 and #4) of the objective lens 20 is an aspherical surface. The following Table 5 shows the cone constants K and aspherical coefficients A₂ᵢ specifying the shape of each of the first surface 11 (surface #1) of the optical element 10 and the first and second surfaces 21 and 22 (surfaces #3 and #4) of the objective lens 20. In Table 5 (and in the following similar Tables), the notation “E” means the power of 10 with an exponent specified by the number to the right of E (e.g. “E-04” means “×10⁻⁴”).

TABLE 5

| Surface No. | K | A4 | A6 | A8 |
|---|---|---|---|---|
| 1 (1^{st} Area) | 0.0000 | −1.9750E−02 | −2.5430E−03 | −2.2110E−04 |
| 1 (2^{nd} Area) | 0.0000 | −2.6750E−02 | 2.9480E−03 | 0.0000E+00 |
| 1 (3^{rd} Area) | 0.0000 | −2.6900E−02 | 3.4775E−03 | −1.3310E−04 |
| 3 | −0.7000 | 6.2270E−03 | 8.1870E−04 | 1.5330E−04 |
| 4 | 0.0000 | 4.7510E−02 | −2.3130E−02 | 6.8280E−03 |

| Surface No. | A10 | A12 |
|---|---|---|
| 1 (1^{st} Area) | 3.8630E−06 | 0.0000E+00 |
| 1 (2^{nd} Area) | 0.0000E+00 | 0.0000E+00 |
| 1 (3^{rd} Area) | 0.0000E+00 | 0.0000E+00 |
| 3 | −2.6270E−06 | 4.4930E−06 |
| 4 | −1.1730E−03 | 8.9920E−05 |

In this example, the first surface 11 of the optical element 10 includes the first area including the optical axis of the optical element 10, the second area formed outside the first area, and the third area (i.e., the outermost area) formed outside the second area. The range with which each of the first to third areas is formed can be expressed as follows by a height h from the optical axis (i.e., by an effective radius).

First Area: 0.000≦h≦1.230

Second Area: 1.230<h≦1.640

Third Area: 1.640<h≦2.125

The first area is configured as a common area contributing to convergence of each of the first to third laser beams. The second area is configured to contribute to convergence of each of the first and second laser beams and not to contribute convergence of the third laser beam. That is, the second area functions as an aperture stop for the third laser beam.

The third area is an area for securing the NA required for information recording/reproducing for the optical disc D1. More specifically, the third area is configured to contribute to convergence of the first laser beam and not to contribute to convergence of each of the second and third laser beams. That is, the third area functions as an aperture stop for the second and third laser beams.

To give the above described different types of functions to the first to third areas, respectively, each of the first to third areas is designed independently to have a unique annular zone structure. More specifically, each of the first and second areas has the annular zone structure defined by two types of optical path difference functions.

Table 6 shows the coefficients P₂ᵢ of the optical path difference function defining the annular zone structure of each of the first to third areas on the first surface 11 of the optical element 10. Table 7 shows the diffraction order m and an effective radius (height from the optical axis) for each of the first to third areas. In Tables 6 and 7 (and in the following similar tables), “OPDF” means an optical path difference function.

TABLE 6

| Area | OPDF | P2 | P4 | P6 |
|---|---|---|---|---|
| 1^{st} | 1^{st} | 0.0000E+00 | −3.4340E+00 | −4.5080E−01 |
| | 2^{nd} | 0.0000E+00 | 8.7200E−01 | 1.2500E−01 |
| 2^{nd} | 3^{rd} | 0.0000E+00 | −2.3480E+00 | −4.8500E−01 |
| | 4^{th} | 0.0000E+00 | −5.1370E+00 | 8.8560E−01 |
| 3^{rd} | 5^{th} | 0.0000E+00 | −4.3239E+01 | 5.5900E+00 |
| Area | OPDF | P8 | P10 | P12 |
| 1^{st} | 1^{st} | −3.3000E−02 | 0.0000E+00 | 0.0000E+00 |
| | 2^{nd} | 1.5170E−03 | 0.0000E+00 | 0.0000E+00 |
| 2^{nd} | 3^{rd} | −4.6500E−02 | 0.0000E+00 | 0.0000E+00 |
| | 4^{th} | 1.9740E−02 | 0.0000E+00 | 0.0000E+00 |
| 3^{rd} | 5^{th} | −2.1395E−01 | 0.0000E+00 | 0.0000E+00 |

TABLE 7

| | | 1^{st} laser | 2^{nd} laser | 3^{rd} laser | effective radius |
|---|---|---|---|---|---|
| Area | OPDF | beam | beam | beam | (mm) |
| 1^{st} | 1^{st} | 10 | 6 | 5 | 1.230 |
| | 2^{nd} | 3 | 2 | 1 | |
| 2^{nd} | 3^{rd} | 3 | 2 | — | 1.640 |
| | 4^{th} | 7 | 4 | — | |
| 3^{rd} | 5^{th} | 1 | — | — | 2.125 |

As shown in Tables 6 and 7, the annular zone structure in the first area of the first surface 11 is configured by combining the two types of optical path difference functions (1^{st} and 2^{nd} OPDFs) different from each other. The annular zone structure in the second area of the first surface 11 is configured by combining the two types of optical path difference functions (3^{rd} and 4^{th} OPDFs) different from each other. The annular zone structure in the third area of the first surface 11 is defined by the 5^{th} optical path difference function.

It should be noted that although in this example the second and tired areas are provided with the annular zone structures, the optical element 10 is able to achieve an adequate optical property when the annular zone structure is formed at least in the first area functions as a common area for the first to third laser beams.

The following Table 8 shows a concrete configuration of the annular zone structure formed in the first area of the optical element 10. In Table 8 (and in the following similar tables), “No.” denotes a number of each annular zone counted from the optical axis, “hmin” and “hmax” denote the range of each annular zone (heights from the optical axis), ΔOPD11/λ₁ denotes an optical path length difference given by a first step (one of the two types of steps) to the first laser beam, ΔOPD21/λ₂ denotes an optical path length difference given by the first step to the second laser beam, ΔOPD31/λ₃ denotes an optical path length difference given by the first step to the third laser beam, ΔOPD12/λ₁ denotes an optical path length difference given by a second step (the other of the two types of steps) to the first laser beam, ΔOPD22/λ₂ denotes an optical path length difference given by the second step to the second laser beam, and ΔOPD32/λ₃ denotes an optical path length difference given by the second step to the third laser beam.

TABLE 8

| | | | ΔOPD11/ | ΔOPD21/ | ΔOPD31/ | ΔOPD12/ | ΔOPD22/ | ΔOPD32/ |
|---|---|---|---|---|---|---|---|---|
| No. | hmin | hmax | λ₁ | λ₂ | λ₃ | λ₁ | λ₂ | λ₃ |
| 0 | 0.000 | 0.610 | | | | | | |
| 1 | 0.610 | 0.796 | −10.34 | −5.85 | −4.84 | 0.00 | 0.00 | 0.00 |
| 2 | 0.796 | 0.849 | −10.34 | −5.85 | −4.84 | 0.00 | 0.00 | 0.00 |
| 3 | 0.849 | 0.899 | 0.00 | 0.00 | 0.00 | 2.87 | 1.62 | 1.34 |
| 4 | 0.899 | 0.974 | −10.34 | −5.85 | −4.84 | 0.00 | 0.00 | 0.00 |
| 5 | 0.974 | 1.033 | −10.34 | −5.85 | −4.84 | 0.00 | 0.00 | 0.00 |
| 6 | 1.033 | 1.082 | −10.34 | −5.85 | −4.84 | 0.00 | 0.00 | 0.00 |
| 7 | 1.082 | 1.100 | −10.34 | −5.85 | −4.84 | 0.00 | 0.00 | 0.00 |
| 8 | 1.100 | 1.125 | 0.00 | 0.00 | 0.00 | 2.87 | 1.62 | 1.34 |
| 9 | 1.125 | 1.163 | −10.34 | −5.85 | −4.84 | 0.00 | 0.00 | 0.00 |
| 10 | 1.163 | 1.197 | −10.34 | −5.85 | −4.84 | 0.00 | 0.00 | 0.00 |
| 11 | 1.197 | 1.230 | −10.34 | −5.85 | −4.84 | 0.00 | 0.00 | 0.00 |

### SECOND EXAMPLE

The objective optical system 30 provided in the optical information recording/reproducing device 100 according to a second example is shown in FIG. 3. The following Table 9 shows concrete specifications of the objective optical system 30 of the objective optical system 100 according to the second example.

TABLE 9

| | 1^{st} laser beam | 2^{nd} laser beam | 3^{rd} laser beam |
|---|---|---|---|
| Wavelength (nm) | 405 | 660 | 790 |
| Focal Length (mm) | 2.50 | 2.59 | 2.61 |
| NA | 0.85 | 0.65 | 0.47 |
| Magnification | 0.000 | 0.000 | 0.000 |

As indicated by the “Magnification” in Table 9, each of the first to third laser beams is incident upon the objective optical system 30 as a collimated beam.

Table 10 shows a specific numerical configuration defined when the optical disc D1 is used in the optical information recording/reproducing device 100 provided with the objective optical system 30 shown in Table 9. The following Table 11 shows specific numerical configuration defined when the optical disc D2 is used in the optical information recording/reproducing device 100 provided with the objective optical system 30 shown in Table 9. The following Table 12 shows specific numerical configuration defined when the optical disc D3 is used in the optical information recording/reproducing device 100 provided with the objective optical system 30 shown in Table 9.

TABLE 10

| Surface No. | r | d | n (405 nm) | |
|---|---|---|---|---|
| 0 | | ∞ | | Light Source 1A |
| 1 (1^{st} Area) | ∞ | 1.00 | 1.65098 | Optical Element |
| 1 (2^{nd} Area) | ∞ | | | |
| 1 (3^{rd} Area) | ∞ | | | |
| 2 | ∞ | 0.50 | | |
| 3 | 1.800 | 2.50 | 1.71557 | Objective Lens |
| 4 | −122.240 | 0.99 | | |
| 5 | ∞ | 0.10 | 1.62231 | Optical Disc D1 |
| 6 | ∞ | — | | |

TABLE 11

| Surface No. | r | d | n (660 nm) | |
|---|---|---|---|---|
| 0 | | ∞ | | Light Source 1B |
| 1 (1^{st} Area) | ∞ | 1.00 | 1.59978 | Optical Element |
| 1 (2^{nd} Area) | ∞ | | | |
| 1 (3^{rd} Area) | ∞ | | | |
| 2 | ∞ | 0.50 | | |
| 3 | 1.800 | 2.50 | 1.68937 | Objective Lens |
| 4 | −122.240 | 0.74 | | |
| 5 | ∞ | 0.60 | 1.57961 | Optical Disc D2 |
| 6 | ∞ | — | | |

TABLE 12

| Surface No. | r | d | n (790 nm) | |
|---|---|---|---|---|
| 0 | | ∞ | | Light Source 1C |
| 1 (1^{st} Area) | ∞ | 1.00 | 1.59073 | Optical Element |
| 1 (2^{nd} Area) | ∞ | | | |
| 1 (3^{rd} Area) | ∞ | | | |
| 2 | ∞ | 0.50 | | |
| 3 | 1.800 | 2.50 | 1.68436 | Objective Lens |
| 4 | −122.240 | 0.38 | | |
| 5 | ∞ | 1.20 | 1.57307 | Optical Disc D3 |
| 6 | ∞ | — | | |

In the Tables 10-12, the surface #0 represents a light source (1A-1C), the surfaces #1 and #2 represent the first and second surfaces 11 and 12 of the optics element 10, respectively, the surfaces #3 and #4 represent the first and second surfaces 21 and 22 of the objective lens 20, and the surfaces #5 and #6 represent the protective layer and the record surface of the corresponding optical disc.

Each of the first surface 11 (surface #1) of the optical element 10 and the first and second surfaces 21 and 22 (surfaces #3 and #4) of the objective lens 20 is an aspherical surface. The following Table 13 shows the cone constants K and aspherical coefficients A₂ᵢ specifying the shape of each of the first surface 11 (surface #1) of the optical element 10 and the first and second surfaces 21 and 22 (surfaces #3 and #4) of the objective lens 20.

TABLE 13

| Surface No. | K | A4 | A6 | A8 | A10 | A12 |
|---|---|---|---|---|---|---|
| 1 (1^{st} Area) | 0.0000 | −1.9230E−03 | −1.0200E−03 | 5.3100E−04 | 3.4810E−06 | 0.0000E+00 |
| 1 (2^{nd} Area) | 0.0000 | −1.3100E−04 | −7.7990E−04 | 0.0000E+00 | 0.0000E+00 | 0.0000E+00 |
| 1 (3^{rd} Area) | 0.0000 | −2.4160E−03 | 2.3885E−04 | −4.8275E−05 | 0.0000E+00 | 0.0000E+00 |
| 3 | −0.7000 | 6.2270E−03 | 8.1870E−04 | 1.5330E−04 | −2.6270E−06 | 4.4930E−06 |
| 4 | 0.0000 | 4.7510E−02 | −2.3130E−02 | 6.8280E−03 | −1.1730E−03 | 8.9920E−05 |

In this example, the first surface 11 of the optical element 10 includes the first area including the optical axis of the optical element 10, the second area formed outside the first area, and the third area (i.e., the outermost area) formed outside the second area. The range with which each of the first to third areas is formed can be expressed as follows by a height h from the optical axis (i.e., by an effective radius).

First Area: 0.000≦h≦1.230

Second Area: 1.230<h≦1.690

Third Area: 1.690<h≦2.125

The first to third areas of the second example respectively have the same functions as those of the first to third areas of the first example. In addition, in this example, each of the first and second areas has the function of suppressing change of the spherical aberration caused when the wavelength of the laser beam being used varies by a minute amount.

Table 14 shows the coefficients P₂ᵢ of the optical path difference function defining the annular zone structure of each of the first to third areas on the first surface 11 of the optical element 10. Table 15 shows the diffraction order m and an effective radius (height from the optical axis) for each of the first to third areas.

TABLE 14

| Area | OPDF | P2 | P4 | P6 |
|---|---|---|---|---|
| 1^{st} | 1^{st} | 0.0000E+00 | −2.5610E+00 | −3.6890E−01 |
| | 2^{nd} | 0.0000E+00 | 2.8700E+00 | 2.8610E−01 |
| | 3^{rd} | 0.0000E+00 | 6.9650E+00 | 5.7390E−01 |
| 2^{nd} | 4^{th} | 0.0000E+00 | 4.6400E+00 | 3.0920E−01 |
| | 5^{th} | 0.0000E+00 | −1.8990E+00 | −3.7360E−01 |
| 3^{rd} | 6^{th} | 0.0000E+00 | −3.8840E+00 | 3.8420E−01 |
| Area | OPDF | P8 | P10 | P12 |
| 1^{st} | 1^{st} | 0.0000E+00 | 0.0000E+00 | 0.0000E+00 |
| | 2^{nd} | 9.0980E−02 | 0.0000E+00 | 0.0000E+00 |
| | 3^{rd} | 3.0420E−01 | 0.0000E+00 | 0.0000E+00 |
| 2^{nd} | 4^{th} | 7.4160E−02 | 0.0000E+00 | 0.0000E+00 |
| | 5^{th} | −2.9840E−02 | 0.0000E+00 | 0.0000E+00 |
| 3^{rd} | 6^{th} | −7.7630E−02 | 0.0000E+00 | 0.0000E+00 |

TABLE 15

| | | 1^{st} laser | 2^{nd} laser | 3^{rd} laser | effective radius |
|---|---|---|---|---|---|
| Area | OPDF | beam | beam | beam | (mm) |
| 1^{st} | 1^{st} | 10 | 6 | 5 | 1.230 |
| | 2^{nd} | 3 | 2 | 1 | |
| | 3^{rd} | 2 | 1 | 1 | |
| 2^{nd} | 4^{th} | 2 | 1 | — | 1.690 |
| | 5^{th} | 5 | 3 | — | |
| 3^{rd} | 6^{th} | 1 | — | — | 2.125 |

As shown in Tables 14 and 15, the annular zone structure in the first area of the first surface 11 is configured by combining the three types of optical path difference functions (1^{st} to 3^{rd} OPDFs) different from each other. The annular zone structure in the second area of the first surface 11 is configured by combining the two types of optical path difference functions (4^{th} and 5^{th} OPDFs) different from each other. The annular zone structure in the third area of the first surface 11 is defined by the 6^{th} optical path difference function.

The following Table 16 shows a concrete configuration of the annular zone structure formed in the first area of the optical element 10. In Table 16, ΔOPD11/λ₁ denotes an optical path length difference given by a first step (one of the three types of steps) to the first laser beam, ΔOPD21/λ₂ denotes an optical path length difference given by the first step to the second laser beam, ΔOPD31/λ₃ denotes an optical path length difference given by the first step to the third laser beam, ΔOPD12/λ₁ denotes an optical path length difference given by a second step (a second type of the three types of steps) to the first laser beam, ΔOPD22/λ₂ denotes an optical path length difference given by the second step to the second laser beam, ΔOPD32/λ₃ denotes an optical path length difference given by the second step to the third laser beam, ΔOPD13/λ₁ denotes an optical path length difference given by a third step (a third type of step of the three types of steps) to the first laser beam, ΔOPD23/λ₂ denotes an optical path length difference given by the third step to the second laser beam, and ΔOPD33/λ₃ denotes an optical path length difference given by the third step to the third laser beam.

TABLE 16

| | | | ΔOPD11/ | ΔOPD21/ | ΔOPD31/ | ΔOPD12/ | ΔOPD22/ | ΔOPD32/ |
|---|---|---|---|---|---|---|---|---|
| No. | hmin | hmax | λ₁ | λ₂ | λ₃ | λ₁ | λ₂ | λ₃ |
| 0 | 0.000 | 0.514 | | | | | | |
| 1 | 0.514 | 0.639 | 0.00 | 0.00 | 0.00 | 0.00 | 0.00 | 0.00 |
| 2 | 0.639 | 0.655 | 0.00 | 0.00 | 0.00 | 2.84 | 1.60 | 1.33 |
| 3 | 0.655 | 0.674 | −10.17 | −5.75 | −4.76 | 0.00 | 0.00 | 0.00 |
| 4 | 0.674 | 0.762 | 0.00 | 0.00 | 0.00 | 0.00 | 0.00 | 0.00 |
| 5 | 0.762 | 0.827 | 0.00 | 0.00 | 0.00 | 0.00 | 0.00 | 0.00 |
| 6 | 0.827 | 0.833 | 0.00 | 0.00 | 0.00 | 0.00 | 0.00 | 0.00 |
| 7 | 0.833 | 0.853 | 0.00 | 0.00 | 0.00 | 2.84 | 1.60 | 1.33 |
| 8 | 0.853 | 0.857 | −10.17 | −5.75 | −4.76 | 0.00 | 0.00 | 0.00 |
| 9 | 0.857 | 0.920 | 0.00 | 0.00 | 0.00 | 0.00 | 0.00 | 0.00 |
| 10 | 0.920 | 0.941 | 0.00 | 0.00 | 0.00 | 0.00 | 0.00 | 0.00 |
| 11 | 0.941 | 0.957 | 0.00 | 0.00 | 0.00 | 2.84 | 1.60 | 1.33 |
| 12 | 0.957 | 0.963 | 0.00 | 0.00 | 0.00 | 0.00 | 0.00 | 0.00 |
| 13 | 0.963 | 0.990 | −10.17 | −5.75 | −4.76 | 0.00 | 0.00 | 0.00 |
| 14 | 0.990 | 1.018 | 0.00 | 0.00 | 0.00 | 0.00 | 0.00 | 0.00 |
| 15 | 1.018 | 1.019 | 0.00 | 0.00 | 0.00 | 2.84 | 1.60 | 1.33 |
| 16 | 1.019 | 1.043 | 0.00 | 0.00 | 0.00 | 0.00 | 0.00 | 0.00 |
| 17 | 1.043 | 1.045 | −10.17 | −5.75 | −4.76 | 0.00 | 0.00 | 0.00 |
| 18 | 1.045 | 1.070 | 0.00 | 0.00 | 0.00 | 0.00 | 0.00 | 0.00 |
| 19 | 1.070 | 1.079 | 0.00 | 0.00 | 0.00 | 0.00 | 0.00 | 0.00 |
| 20 | 1.079 | 1.092 | 0.00 | 0.00 | 0.00 | 2.84 | 1.60 | 1.33 |
| 21 | 1.092 | 1.106 | 0.00 | 0.00 | 0.00 | 0.00 | 0.00 | 0.00 |
| 22 | 1.106 | 1.113 | −10.17 | −5.75 | −4.76 | 0.00 | 0.00 | 0.00 |
| 23 | 1.113 | 1.129 | 0.00 | 0.00 | 0.00 | 0.00 | 0.00 | 0.00 |
| 24 | 1.129 | 1.133 | 0.00 | 0.00 | 0.00 | 2.84 | 1.60 | 1.33 |
| 25 | 1.133 | 1.151 | 0.00 | 0.00 | 0.00 | 0.00 | 0.00 | 0.00 |
| 26 | 1.151 | 1.158 | 0.00 | 0.00 | 0.00 | 0.00 | 0.00 | 0.00 |
| 27 | 1.158 | 1.168 | −10.17 | −5.75 | −4.76 | 0.00 | 0.00 | 0.00 |
| 28 | 1.168 | 1.173 | 0.00 | 0.00 | 0.00 | 0.00 | 0.00 | 0.00 |
| 29 | 1.173 | 1.185 | 0.00 | 0.00 | 0.00 | 2.84 | 1.60 | 1.33 |
| 30 | 1.185 | 1.201 | 0.00 | 0.00 | 0.00 | 0.00 | 0.00 | 0.00 |
| 31 | 1.201 | 1.204 | 0.00 | 0.00 | 0.00 | 0.00 | 0.00 | 0.00 |
| 32 | 1.204 | 1.211 | −10.17 | −5.75 | −4.76 | 0.00 | 0.00 | 0.00 |
| 33 | 1.211 | 1.215 | 0.00 | 0.00 | 0.00 | 2.84 | 1.60 | 1.33 |
| 34 | 1.215 | 1.230 | 0.00 | 0.00 | 0.00 | 0.00 | 0.00 | 0.00 |

| | | | ΔOPD13/ | ΔOPD23/ | ΔOPD33/ |
|---|---|---|---|---|---|
| No. | hmin | hmax | λ₁ | λ₂ | λ₃ |
| 0 | 0.000 | 0.514 | | | |
| 1 | 0.514 | 0.639 | 2.00 | 1.13 | 0.94 |
| 2 | 0.639 | 0.655 | 0.00 | 0.00 | 0.00 |
| 3 | 0.655 | 0.674 | 0.00 | 0.00 | 0.00 |
| 4 | 0.674 | 0.762 | 2.00 | 1.13 | 0.94 |
| 5 | 0.762 | 0.827 | 2.00 | 1.13 | 0.94 |
| 6 | 0.827 | 0.833 | 2.00 | 1.13 | 0.94 |
| 7 | 0.833 | 0.853 | 0.00 | 0.00 | 0.00 |
| 8 | 0.853 | 0.857 | 0.00 | 0.00 | 0.00 |
| 9 | 0.857 | 0.920 | 2.00 | 1.13 | 0.94 |
| 10 | 0.920 | 0.941 | 2.00 | 1.13 | 0.94 |
| 11 | 0.941 | 0.957 | 0.00 | 0.00 | 0.00 |
| 12 | 0.957 | 0.963 | 2.00 | 1.13 | 0.94 |
| 13 | 0.963 | 0.990 | 0.00 | 0.00 | 0.00 |
| 14 | 0.990 | 1.018 | 2.00 | 1.13 | 0.94 |
| 15 | 1.018 | 1.019 | 0.00 | 0.00 | 0.00 |
| 16 | 1.019 | 1.043 | 2.00 | 1.13 | 0.94 |
| 17 | 1.043 | 1.045 | 0.00 | 0.00 | 0.00 |
| 18 | 1.045 | 1.070 | 2.00 | 1.13 | 0.94 |
| 19 | 1.070 | 1.079 | 2.00 | 1.13 | 0.94 |
| 20 | 1.079 | 1.092 | 0.00 | 0.00 | 0.00 |
| 21 | 1.092 | 1.106 | 2.00 | 1.13 | 0.94 |
| 22 | 1.106 | 1.113 | 0.00 | 0.00 | 0.00 |
| 23 | 1.113 | 1.129 | 2.00 | 1.13 | 0.94 |
| 24 | 1.129 | 1.133 | 0.00 | 0.00 | 0.00 |
| 25 | 1.133 | 1.151 | 2.00 | 1.13 | 0.94 |
| 26 | 1.151 | 1.158 | 2.00 | 1.13 | 0.94 |
| 27 | 1.158 | 1.168 | 0.00 | 0.00 | 0.00 |
| 28 | 1.168 | 1.173 | 2.00 | 1.13 | 0.94 |
| 29 | 1.173 | 1.185 | 0.00 | 0.00 | 0.00 |
| 30 | 1.185 | 1.201 | 2.00 | 1.13 | 0.94 |
| 31 | 1.201 | 1.204 | 2.00 | 1.13 | 0.94 |
| 32 | 1.204 | 1.211 | 0.00 | 0.00 | 0.00 |
| 33 | 1.211 | 1.215 | 0.00 | 0.00 | 0.00 |
| 34 | 1.215 | 1.230 | 2.00 | 1.13 | 0.94 |

### THIRD EXAMPLE

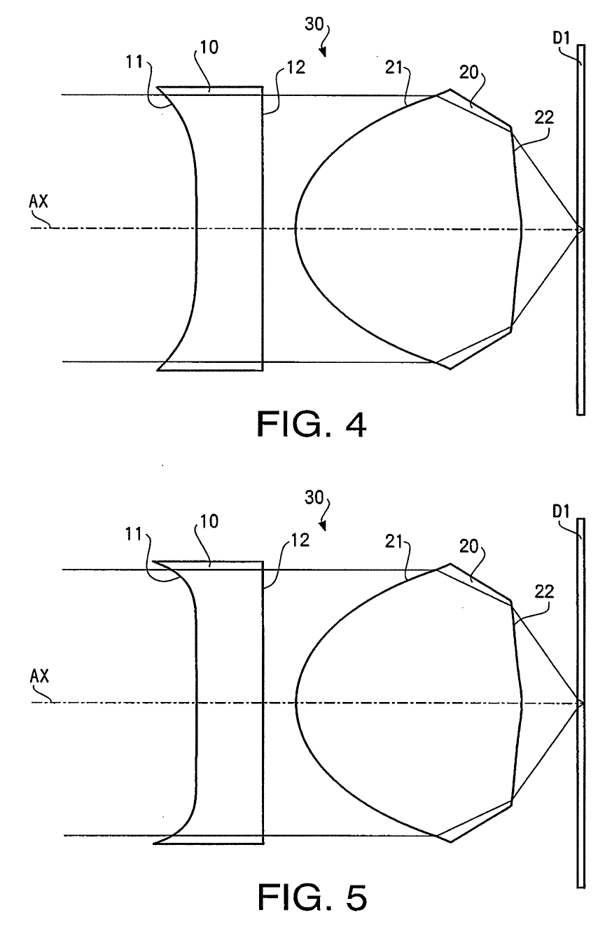

The objective optical system 30 provided in the optical information recording/reproducing device 100 according to a third example is shown in FIG. 4. The following Table 17 shows concrete specifications of the objective optical system 30 of the objective optical system 100 according to the second example.

TABLE 17

| | 1^{st} laser beam | 2^{nd} laser beam | 3^{rd} laser beam |
|---|---|---|---|
| Wavelength (nm) | 405 | 660 | 790 |
| Focal Length (mm) | 2.70 | 2.77 | 2.79 |
| NA | 0.85 | 0.60 | 0.45 |
| Magnification | 0.000 | 0.000 | 0.000 |

As indicated by the “Magnification” in Table 17, each of the first to third laser beams is incident upon the objective optical system 30 as a collimated beam.

Table 18 shows a specific numerical configuration defined when the optical disc D1 is used in the optical information recording/reproducing device 100 provided with the objective optical system 30 shown in Table 17. The following Table 19 shows specific numerical configuration defined when the optical disc D2 is used in the optical information recording/reproducing device 100 provided with the objective optical system 30 shown in Table 17. The following Table 20 shows specific numerical configuration defined when the optical disc D3 is used in the optical information recording/reproducing device 100 provided with the objective optical system 30 shown in Table 17.

TABLE 18

| Surface No. | r | d | n (405 nm) | |
|---|---|---|---|---|
| 0 | | ∞ | | Light Source 1A |
| 1 (1^{st} Area) | ∞ | 1.00 | 1.62309 | Optical Element |
| 1 (2^{nd} Area) | ∞ | | | |
| 1 (3^{rd} Area) | ∞ | | | |
| 2 | ∞ | 0.50 | | |
| 3 | 1.736 | 3.35 | 1.52469 | Objective Lens |
| 4 | −2.587 | 0.85 | | |
| 5 | ∞ | 0.10 | 1.62231 | Optical Disc D1 |
| 6 | ∞ | — | | |

TABLE 19

| Surface No. | r | d | n (660 nm) | |
|---|---|---|---|---|
| 0 | | ∞ | | Light Source 1B |
| 1 (1^{st} Area) | ∞ | 1.00 | 1.58760 | Optical Element |
| 1 (2^{nd} Area) | ∞ | | | |
| 1 (3^{rd} Area) | ∞ | | | |
| 2 | ∞ | 0.50 | | |
| 3 | 1.736 | 3.35 | 1.50635 | Objective Lens |
| 4 | −2.587 | 0.60 | | |
| 5 | ∞ | 0.60 | 1.57961 | Optical Disc D2 |
| 6 | ∞ | — | | |

TABLE 20

| Surface No. | r | d | n (790 nm) | |
|---|---|---|---|---|
| 0 | | ∞ | | Light Source 1C |
| 1 (1^{st} Area) | ∞ | 1.00 | 1.58169 | Optical Element |
| 1 (2^{nd} Area) | ∞ | | | |
| 1 (3^{rd} Area) | ∞ | | | |
| 2 | ∞ | 0.50 | | |
| 3 | 1.736 | 3.35 | 1.50313 | Objective Lens |
| 4 | −2.587 | 0.22 | | |
| 5 | ∞ | 1.20 | 1.57307 | Optical Disc D3 |
| 6 | ∞ | — | | |

In the Tables 18-20, the surface #0 represents a light source (1A-1C), the surfaces #1 and #2 represent the first and second surfaces 11 and 12 of the optical element 10, respectively, the surfaces #3 and #4 represent the first and second surfaces 21 and 22 of the objective lens 20, and the surfaces #5 and #6 represent the protective layer and the record surface of the corresponding optical disc.

Each of the first surface 11 (surface #1) of the optical element 10 and the first and second surfaces 21 and 22 (surfaces #3 and #4) of the objective lens 20 is an aspherical surface. The following Table 21 shows the cone constants K and aspherical coefficients A₂ᵢ specifying the shape of each of the first surface 11 (surface #1) of the optical element 10 and the first and second surfaces 21 and 22 (surfaces #3 and #4) of the objective lens 20.

TABLE 21

| Sur- | | | | |
|---|---|---|---|---|
| face | | | | |
| No. | K | A4 | A6 | A8 |
| 1 (1^{st} | 0.0000 | −1.4703E−02 | −1.1628E−03 | 1.3225E−04 |
| Area) | | | | |
| 1 (2^{nd} | 0.0000 | −1.8455E−02 | 1.0866E−03 | 1.2047E−04 |
| Area) | | | | |
| 1 (3^{rd} | 0.0000 | −1.4750E−02 | 1.6920E−04 | 3.1507E−05 |
| Area) | | | | |
| 3 | −0.7000 | 4.9746E−03 | 1.8666E−03 | −2.0415E−03 |
| 4 | 0.0000 | 2.6830E−01 | −3.6928E−01 | 3.8790E−01 |
| Sur- | | | | |
| face | | | | |
| No. | A10 | A12 | A14 | A16 |
| 1 (1^{st} | 0.0000E+00 | 0.0000E+00 | 0.0000E+00 | 0.0000E+00 |
| Area) | | | | |
| 1 (2^{nd} | 0.0000E+00 | 0.0000E+00 | 0.0000E+00 | 0.0000E+00 |
| Area) | | | | |
| 1 (3^{rd} | 0.0000E+00 | 0.0000E+00 | 0.0000E+00 | 0.0000E+00 |
| Area) | | | | |
| 3 | 1.9873E−03 | −1.1062E−03 | 3.7590E−04 | −7.8228E−05 |
| 4 | −2.6586E−01 | 1.1812E−01 | −3.4003E−02 | 6.1512E−03 |
| Sur- | | | | |
| face | | | | |
| No. | A18 | A20 | A22 | A24 |
| 1 (1^{st} | 0.0000E+00 | 0.0000E+00 | 0.0000E+00 | 0.0000E+00 |
| Area) | | | | |
| 1 (2^{nd} | 0.0000E+00 | 0.0000E+00 | 0.0000E+00 | 0.0000E+00 |
| Area) | | | | |
| 1 (3^{rd} | 0.0000E+00 | 0.0000E+00 | 0.0000E+00 | 0.0000E+00 |
| Area) | | | | |
| 3 | 9.3357E−06 | −4.8822E−07 | 0.0000E+00 | 0.0000E+00 |
| 4 | −6.3833E−04 | 2.9109E−05 | 0.0000E+00 | 0.0000E+00 |

In this example, the first surface 11 of the optical element 10 includes the first area including the optical axis of the optical element 10, the second area formed outside the first area, and the third area (i.e., the outermost area) formed outside the second area. The range with which each of the first to third areas is formed can be expressed as follows by a height h from the optical axis (i.e., by an effective radius).

First Area: 0.000≦h≦1.250

Second Area: 1.250<h≦1.665

Third Area: 1.665<h≦2.295

The first to third areas of the third example respectively have the same functions as those of the first to third areas of the first example.

Table 22 shows the coefficients P₂ᵢ of the optical path difference function defining the annular zone structure of each of the first to third areas on the first surface 11 of the optical element 10. Table 23 shows the diffraction order m and an effective radius (height from the optical axis) for each of the first to third areas.

TABLE 22

| Area | OPDF | P2 | P4 | P6 |
|---|---|---|---|---|
| 1^{st} | 1^{st} | 0.0000E+00 | −3.4250E+00 | −1.6110E−01 |
| | 2^{nd} | 0.0000E+00 | 1.6610E+00 | −2.5190E−02 |
| 2^{nd} | 3^{rd} | 0.0000E+00 | −1.2700E+00 | −1.0540E−01 |
| | 4^{th} | 0.0000E+00 | −4.9160E+00 | 3.9730E−01 |
| 3^{rd} | 5^{th} | 0.0000E+00 | −2.2690E+01 | 2.5880E−01 |
| Area | OPDF | P8 | P10 | P12 |
| 1^{st} | 1^{st} | −3.5220E−02 | 0.0000E+00 | 0.0000E+00 |
| | 2^{nd} | 7.9350E−02 | 0.0000E+00 | 0.0000E+00 |
| 2^{nd} | 3^{rd} | −1.4050E−01 | 0.0000E+00 | 0.0000E+00 |
| | 4^{th} | 1.2140E−01 | 0.0000E+00 | 0.0000E+00 |
| 3^{rd} | 5^{th} | 4.8690E−02 | 0.0000E+00 | 0.0000E+00 |

TABLE 23

| | | 1^{st} laser | 2^{nd} laser | 3^{rd} laser | effective radius |
|---|---|---|---|---|---|
| Area | OPDF | beam | beam | beam | (mm) |
| 1^{st} | 1^{st} | 10 | 6 | 5 | 1.250 |
| | 2^{nd} | 7 | 4 | 3 | |
| 2^{nd} | 3^{rd} | 3 | 2 | — | 1.665 |
| | 4^{th} | 5 | 3 | — | |
| 3^{rd} | 5^{th} | 1 | — | — | 2.295 |

As shown in Tables 22 and 23, the annular zone structure in the first area of the first surface 11 is configured by combining the two types of optical path difference functions (1^{st} and 2^{nd} OPDFs) different from each other. The annular zone structure in the second area of the first surface 11 is configured by combining the two types of optical path difference functions (3^{rd} and 4^{th} OPDFs) different from each other. The annular zone structure in the third area of the first surface 11 is defined by the 5^{th} optical path difference function.

The following Table 24 shows a concrete configuration of the annular zone structure formed in the first area. In Table 24, ΔOPD11/λ₁ denotes an optical path length difference given by a first step (one of the two types of steps) to the first laser beam, ΔOPD21/λ₂ denotes an optical path length difference given by the first step to the second laser beam, ΔOPD31/λ₃ denotes an optical path length difference given by the first step to the third laser beam, ΔOPD12/λ₁ denotes an optical path length difference given by a second step (the other of the two types of steps) to the first laser beam, ΔOPD22/λ₂ denotes an optical path length difference given by the second step to the second laser beam, and ΔOPD32/λ₃ denotes an optical path length difference given by the second step to the third laser beam.

TABLE 24

| | hmin | hmax | ΔOPD11/ | ΔOPD21/ | ΔOPD31/ | ΔOPD12/ | ΔOPD22/ | ΔOPD32/ |
|---|---|---|---|---|---|---|---|---|
| No | (mm) | (mm) | λ₁ | λ₂ | λ₃ | λ₁ | λ₂ | λ₃ |
| 0 | 0.000 | 0.615 | | | | | | |
| 1 | 0.615 | 0.740 | −10.00 | −6.13 | −4.89 | 0.00 | 0.00 | 0.00 |
| 2 | 0.740 | 0.807 | 0.00 | 0.00 | 0.00 | 6.79 | 4.16 | 3.32 |
| 3 | 0.807 | 0.914 | −10.00 | −6.13 | −4.89 | 0.00 | 0.00 | 0.00 |
| 4 | 0.914 | 0.968 | −10.00 | −6.13 | −4.89 | 0.00 | 0.00 | 0.00 |
| 5 | 0.968 | 0.992 | 0.00 | 0.00 | 0.00 | 6.79 | 4.16 | 3.32 |
| 6 | 0.992 | 1.054 | −10.00 | −6.13 | −4.89 | 0.00 | 0.00 | 0.00 |
| 7 | 1.054 | 1.094 | −10.00 | −6.13 | −4.89 | 0.00 | 0.00 | 0.00 |
| 8 | 1.094 | 1.106 | 0.00 | 0.00 | 0.00 | 6.79 | 4.16 | 3.32 |
| 9 | 1.106 | 1.151 | −10.00 | −6.13 | −4.89 | 0.00 | 0.00 | 0.00 |
| 10 | 1.151 | 1.184 | −10.00 | −6.13 | −4.89 | 0.00 | 0.00 | 0.00 |
| 11 | 1.184 | 1.191 | 0.00 | 0.00 | 0.00 | 6.79 | 4.16 | 3.32 |
| 12 | 1.191 | 1.227 | −10.00 | −6.13 | −4.89 | 0.00 | 0.00 | 0.00 |
| 13 | 1.227 | 1.250 | −10.00 | −6.13 | −4.89 | 0.00 | 0.00 | 0.00 |

### FOURTH EXAMPLE

The objective optical system 30 provided in the optical information recording/reproducing device 100 according to a third example is shown in FIG. 5. The following Table 25 shows concrete specifications of the objective optical system 30 of the objective optical system 100 according to the second example.

TABLE 25

| | 1^{st} laser beam | 2^{nd} laser beam | 3^{rd} laser beam |
|---|---|---|---|
| Wavelength (nm) | 405 | 660 | 790 |
| Focal Length (mm) | 2.70 | 2.77 | 2.79 |
| NA | 0.85 | 0.60 | 0.45 |
| Magnification | 0.000 | 0.000 | 0.000 |

As indicated by the “Magnification” in Table 25, each of the first to third laser beams is incident upon the objective optical system 30 as a collimated beam.

Table 26 shows a specific numerical configuration defined when the optical disc D1 is used in the optical information recording/reproducing device 100 provided with the objective optical system 30 shown in Table 25. The following Table 27 shows specific numerical configuration defined when the optical disc D2 is used in the optical information recording/reproducing device 100 provided with the objective optical system 30 shown in Table 25. The following Table 28 shows specific numerical configuration defined when the optical disc D3 is used in the optical information recording/reproducing device 100 provided with the objective optical system 30 shown in Table 25.

TABLE 26

| Surface No. | r | d | n (405 nm) | |
|---|---|---|---|---|
| 0 | | ∞ | | Light Source 1A |
| 1 (1^{st} Area) | ∞ | 1.00 | 1.62309 | Optical Element |
| 1 (2^{nd} Area) | ∞ | | | |
| 1 (3^{rd} Area) | ∞ | | | |
| 2 | ∞ | 0.50 | | |
| 3 | 1.736 | 3.35 | 1.52469 | Objective Lens |
| 4 | −2.587 | 0.85 | | |
| 5 | ∞ | 0.10 | 1.62231 | Optical Disc D1 |
| 6 | ∞ | — | | |

TABLE 27

| Surface No. | r | d | n (660 nm) | |
|---|---|---|---|---|
| 0 | | ∞ | | Light Source 1B |
| 1 (1^{st} Area) | ∞ | 1.00 | 1.58760 | Optical Element |
| 1 (2^{nd} Area) | ∞ | | | |
| 1 (3^{rd} Area) | ∞ | | | |
| 2 | ∞ | 0.50 | | |
| 3 | 1.736 | 3.35 | 1.50635 | Objective Lens |
| 4 | −2.587 | 0.59 | | |
| 5 | ∞ | 0.60 | 1.57961 | Optical Disc D2 |
| 6 | ∞ | — | | |

TABLE 28

| Surface No. | r | d | n (790 nm) | |
|---|---|---|---|---|
| 0 | | ∞ | | Light Source 1C |
| 1 (1^{st} Area) | ∞ | 1.00 | 1.58169 | Optical Element |
| 1 (2^{nd} Area) | ∞ | | | |
| 1 (3^{rd} Area) | ∞ | | | |
| 2 | ∞ | 0.50 | | |
| 3 | 1.736 | 3.35 | 1.50313 | Objective Lens |
| 4 | −2.587 | 0.22 | | |
| 5 | ∞ | 1.20 | 1.57307 | Optical Disc D3 |
| 6 | ∞ | — | | |

In the Tables 26-28, the surface #0 represents a light source (1A-1C), the surfaces #1 and #2 represent the first and second surfaces 11 and 12 of the optical element 10, respectively, the surfaces #3 and #4 represent the first and second surfaces 21 and 22 of the objective lens 20, and the surfaces #5 and #6 represent the protective layer and the record surface of the corresponding optical disc.

Each of the first surface 11 (surface #1) of the optical element 10 and the first and second surfaces 21 and 22 (surfaces #3 and #4) of the objective lens 20 is an aspherical surface. The following Table 29 shows the cone constants K and aspherical coefficients A₂ᵢ specifying the shape of each of the first surface 11 (surface #1) of the optical element 10 and the first and second surfaces 21 and 22 (surfaces #3 and #4) of the objective lens 20.

TABLE 29

| Sur- | | | | |
|---|---|---|---|---|
| face | | | | |
| No. | K | A4 | A6 | A8 |
| 1 (1^{st} | 0.0000 | −7.7170E−03 | 4.7202E−03 | −1.1602E−03 |
| Area) | | | | |
| 1 (2^{nd} | 0.0000 | 3.4180E−05 | −4.6970E−04 | −3.7702E−04 |
| Area) | | | | |
| 1 (3^{rd} | 0.0000 | −4.4050E−03 | −1.3765E−04 | −1.7654E−05 |
| Area) | | | | |
| 3 | −0.7000 | 4.9746E−03 | 1.8666E−03 | −2.0415E−03 |
| 4 | 0.0000 | 2.6830E−01 | −3.6928E−01 | 3.8790E−01 |
| Sur- | | | | |
| face | | | | |
| No. | A10 | A12 | A14 | A16 |
| 1 (1^{st} | 0.0000E+00 | 0.0000E+00 | 0.0000E+00 | 0.0000E+00 |
| Area) | | | | |
| 1 (2^{nd} | 0.0000E+00 | 0.0000E+00 | 0.0000E+00 | 0.0000E+00 |
| Area) | | | | |
| 1 (3^{rd} | 0.0000E+00 | 0.0000E+00 | 0.0000E+00 | 0.0000E+00 |
| Area) | | | | |
| 3 | 1.9873E−03 | −1.1062E−03 | 3.7590E−04 | −7.8228E−05 |
| 4 | −2.6586E−01 | 1.1812E−01 | −3.4003E−02 | 6.1512E−03 |
| Sur- | | | | |
| face | | | | |
| No. | A18 | A20 | A22 | A24 |
| 1 (1^{st} | 0.0000E+00 | 0.0000E+00 | 0.0000E+00 | 0.0000E+00 |
| Area) | | | | |
| 1 (2^{nd} | 0.0000E+00 | 0.0000E+00 | 0.0000E+00 | 0.0000E+00 |
| Area) | | | | |
| 1 (3^{rd} | 0.0000E+00 | 0.0000E+00 | 0.0000E+00 | 0.0000E+00 |
| Area) | | | | |
| 3 | 9.3357E−06 | −4.8822E−07 | 0.0000E+00 | 0.0000E+00 |
| 4 | −6.3833E−04 | 2.9109E−05 | 0.0000E+00 | 0.0000E+00 |

In this example, the first surface 11 of the optical element 10 includes the first area including the optical axis of the optical element 10, the second area formed outside the first area, and the third area (i.e., the outermost area) formed outside the second area. The range with which each of the first to third areas is formed can be expressed as follows by a height h from the optical axis (i.e., by an effective radius).

First Area: 0.000≦h≦1.250

Second Area: 1.250<h≦1.665

Third Area: 1.665<h≦2.295

The first to third areas of the fourth example respectively have the same functions as those of the first to third areas of the first example.

Table 30 shows the coefficients P₂ᵢ of the optical path difference function defining the annular zone structure of each of the first to third areas on the first surface 11 of the optical element 10. Table 31 shows the diffraction order m and an effective radius (height from the optical axis) for each of the first to third areas.

TABLE 30

| Area | OPDF | P2 | P4 | P6 |
|---|---|---|---|---|
| 1^{st} | 1^{st} | 0.0000E+00 | −2.7810E+00 | 3.0670E−01 |
| | 2^{nd} | 0.0000E+00 | 2.0670E+00 | 4.5820E−01 |
| | 3^{rd} | 0.0000E+00 | 4.8670E+00 | 1.4110E+00 |
| 2^{nd} | 4^{th} | 0.0000E+00 | −3.0100E+00 | 3.6860E−02 |
| | 5^{th} | 0.0000E+00 | 1.2980E+00 | −1.1930E−01 |
| 3^{rd} | 6^{th} | 0.0000E+00 | −6.7740E+00 | −2.1350E−01 |
| Area | OPDF | P8 | P10 | P12 |
| 1^{st} | 1^{st} | −1.2800E−01 | 0.0000E+00 | 0.0000E+00 |
| | 2^{nd} | −4.5720E−02 | 0.0000E+00 | 0.0000E+00 |
| | 3^{rd} | −1.8400E−01 | 0.0000E+00 | 0.0000E+00 |
| 2^{nd} | 4^{th} | −1.0070E−01 | 0.0000E+00 | 0.0000E+00 |
| | 5^{th} | −3.9670E−02 | 0.0000E+00 | 0.0000E+00 |
| 3^{rd} | 6^{th} | −2.6910E−02 | 0.0000E+00 | 0.0000E+00 |

TABLE 31

| | | 1^{st} laser | 2^{nd} laser | 3^{rd} laser | effective radius |
|---|---|---|---|---|---|
| Area | OPDF | beam | beam | beam | (mm) |
| 1^{st} | 1^{st} | 10 | 6 | 5 | 1.250 |
| | 2^{nd} | 3 | 2 | 1 | |
| | 3^{rd} | 2 | 1 | 1 | |
| 2^{nd} | 4^{th} | 3 | 2 | — | 1.665 |
| | 5^{th} | 7 | 4 | — | |
| 3^{rd} | 6^{th} | 1 | — | — | 2.295 |

As shown in Tables 30 and 31, the annular zone structure in the first area of the first surface 11 is configured by combining the three types of optical path difference functions (1^{st} to 3^{rd} OPDFs) different from each other. The annular zone structure in the second area of the first surface 11 is configured by combining the two types of optical path difference functions (4^{th} and 5^{th} OPDFs) different from each other. The annular zone structure in the third area of the first surface 11 is defined by the 6^{th} optical path difference function.

The following Table 32 shows a concrete configuration of the annular zone structure formed in the first area. In Table 32, ΔOPD11/λ₁ denotes an optical path length difference given by a first step (one of the three types of steps) to the first laser beam, ΔOPD21/λ₂ denotes an optical path length difference given by the first step to the second laser beam, ΔOPD31/λ₃ denotes an optical path length difference given by the first step to the third laser beam, ΔOPD12/λ₁ denotes an optical path length difference given by a second step (a second type of the three types of steps) to the first laser beam, ΔOPD22/λ₂ denotes an optical path length difference given by the second step to the second laser beam, ΔOPD32/λ₃ denotes an optical path length difference given by the second step to the third laser beam, ΔOPD13/λ₁ denotes an optical path length difference given by a third step (a third type of step of the three types of steps) to the first laser beam, ΔOPD23/λ₂ denotes an optical path length difference given by the third step to the second laser beam, and ΔOPD33/λ₃ denotes an optical path length difference given by the third step to the third laser beam.

TABLE 32

| | hmin | hmax | ΔOPD11/ | ΔOPD21/ | ΔOPD31/ | ΔOPD12/ | ΔOPD22/ | ΔOPD32/ |
|---|---|---|---|---|---|---|---|---|
| No | (mm) | (mm) | λ₁ | λ₂ | λ₃ | λ₁ | λ₂ | λ₃ |
| 0 | 0.000 | 0.555 | | | | | | |
| 1 | 0.555 | 0.658 | 0.00 | 0.00 | 0.00 | 0.00 | 0.00 | 0.00 |
| 2 | 0.658 | 0.685 | −10.30 | −6.31 | −5.04 | 0.00 | 0.00 | 0.00 |
| 3 | 0.685 | 0.721 | 0.00 | 0.00 | 0.00 | 2.77 | 1.70 | 1.36 |
| 4 | 0.721 | 0.813 | 0.00 | 0.00 | 0.00 | 0.00 | 0.00 | 0.00 |
| 5 | 0.813 | 0.870 | 0.00 | 0.00 | 0.00 | 0.00 | 0.00 | 0.00 |
| 6 | 0.870 | 0.880 | −10.30 | −6.31 | −5.04 | 0.00 | 0.00 | 0.00 |
| 7 | 0.880 | 0.889 | 0.00 | 0.00 | 0.00 | 0.00 | 0.00 | 0.00 |
| 8 | 0.889 | 0.932 | 0.00 | 0.00 | 0.00 | 2.77 | 1.70 | 1.36 |
| 9 | 0.932 | 0.977 | 0.00 | 0.00 | 0.00 | 0.00 | 0.00 | 0.00 |
| 10 | 0.977 | 0.990 | 0.00 | 0.00 | 0.00 | 0.00 | 0.00 | 0.00 |
| 11 | 0.990 | 1.002 | −10.30 | −6.31 | −5.04 | 0.00 | 0.00 | 0.00 |
| 12 | 1.002 | 1.015 | 0.00 | 0.00 | 0.00 | 2.77 | 1.70 | 1.36 |
| 13 | 1.015 | 1.049 | 0.00 | 0.00 | 0.00 | 0.00 | 0.00 | 0.00 |
| 14 | 1.049 | 1.077 | 0.00 | 0.00 | 0.00 | 0.00 | 0.00 | 0.00 |
| 15 | 1.077 | 1.079 | −10.30 | −6.31 | −5.04 | 0.00 | 0.00 | 0.00 |
| 16 | 1.079 | 1.083 | 0.00 | 0.00 | 0.00 | 0.00 | 0.00 | 0.00 |
| 17 | 1.083 | 1.107 | 0.00 | 0.00 | 0.00 | 2.77 | 1.70 | 1.36 |
| 18 | 1.107 | 1.133 | 0.00 | 0.00 | 0.00 | 0.00 | 0.00 | 0.00 |
| 19 | 1.133 | 1.147 | 0.00 | 0.00 | 0.00 | 0.00 | 0.00 | 0.00 |
| 20 | 1.147 | 1.148 | −10.30 | −6.31 | −5.04 | 0.00 | 0.00 | 0.00 |
| 21 | 1.148 | 1.157 | 0.00 | 0.00 | 0.00 | 2.77 | 1.70 | 1.36 |
| 22 | 1.157 | 1.179 | 0.00 | 0.00 | 0.00 | 0.00 | 0.00 | 0.00 |
| 23 | 1.179 | 1.200 | 0.00 | 0.00 | 0.00 | 0.00 | 0.00 | 0.00 |
| 24 | 1.200 | 1.202 | 0.00 | 0.00 | 0.00 | 0.00 | 0.00 | 0.00 |
| 25 | 1.202 | 1.205 | 0.00 | 0.00 | 0.00 | 2.77 | 1.70 | 1.36 |
| 26 | 1.205 | 1.219 | −10.30 | −6.31 | −5.04 | 0.00 | 0.00 | 0.00 |
| 27 | 1.219 | 1.238 | 0.00 | 0.00 | 0.00 | 0.00 | 0.00 | 0.00 |
| 28 | 1.238 | 1.250 | 0.00 | 0.00 | 0.00 | 0.00 | 0.00 | 0.00 |

| | hmin | hmax | ΔOPD13/ | ΔOPD23/ | ΔOPD33/ |
|---|---|---|---|---|---|
| No | (mm) | (mm) | λ₁ | λ₂ | λ₃ |
| 0 | 0.000 | 0.555 | | | |
| 1 | 0.555 | 0.658 | 2.06 | 1.26 | 1.01 |
| 2 | 0.658 | 0.685 | 0.00 | 0.00 | 0.00 |
| 3 | 0.685 | 0.721 | 0.00 | 0.00 | 0.00 |
| 4 | 0.721 | 0.813 | 2.06 | 1.26 | 1.01 |
| 5 | 0.813 | 0.870 | 2.06 | 1.26 | 1.01 |
| 6 | 0.870 | 0.880 | 0.00 | 0.00 | 0.00 |
| 7 | 0.880 | 0.889 | 2.06 | 1.26 | 1.01 |
| 8 | 0.889 | 0.932 | 0.00 | 0.00 | 0.00 |
| 9 | 0.932 | 0.977 | 2.06 | 1.26 | 1.01 |
| 10 | 0.977 | 0.990 | 2.06 | 1.26 | 1.01 |
| 11 | 0.990 | 1.002 | 0.00 | 0.00 | 0.00 |
| 12 | 1.002 | 1.015 | 0.00 | 0.00 | 0.00 |
| 13 | 1.015 | 1.049 | 2.06 | 1.26 | 1.01 |
| 14 | 1.049 | 1.077 | 2.06 | 1.26 | 1.01 |
| 15 | 1.077 | 1.079 | 0.00 | 0.00 | 0.00 |
| 16 | 1.079 | 1.083 | 2.06 | 1.26 | 1.01 |
| 17 | 1.083 | 1.107 | 0.00 | 0.00 | 0.00 |
| 18 | 1.107 | 1.133 | 2.06 | 1.26 | 1.01 |
| 19 | 1.133 | 1.147 | 2.06 | 1.26 | 1.01 |
| 20 | 1.147 | 1.148 | 0.00 | 0.00 | 0.00 |
| 21 | 1.148 | 1.157 | 0.00 | 0.00 | 0.00 |
| 22 | 1.157 | 1.179 | 2.06 | 1.26 | 1.01 |
| 23 | 1.179 | 1.200 | 2.06 | 1.26 | 1.01 |
| 24 | 1.200 | 1.202 | 2.06 | 1.26 | 1.01 |
| 25 | 1.202 | 1.205 | 0.00 | 0.00 | 0.00 |
| 26 | 1.205 | 1.219 | 0.00 | 0.00 | 0.00 |
| 27 | 1.219 | 1.238 | 2.06 | 1.26 | 1.01 |
| 28 | 1.238 | 1.250 | 2.06 | 1.26 | 1.01 |

The following Table 33 shows values of the conditions of the above described first to fourth examples. All of the first to fourth examples satisfy at least the conditions (1), (2)-(4), (7)-(9) and (12).

TABLE 33

| | 1^{st} | | | 4^{th} |
|---|---|---|---|---|
| Conditions | EXAMPLE | 2^{nd} EXAMPLE | 3^{rd} EXAMPLE | EXAMPLE |
| (1) | 27.2 | 27.2 | 35.4 | 35.4 |
| (2)(5) | 0.061 | 0.061 | 0.037 | 0.037 |
| (3) | 0.075 | 0.075 | 0.045 | 0.045 |
| (4)(6) | −88.6 | −47.3 | −60.8 | −44.3 |
| (7)(10) | 0.061 | 0.061 | 0.037 | 0.037 |
| (8) | 0.075 | 0.075 | 0.045 | 0.045 |
| (9)(11) | −87.3 | −48.5 | −62.8 | −45.2 |
| (12) | 10.34 | 10.17 | 10.00 | 10.30 |

By satisfying the condition (12), it is possible to secure high use efficiency of light for each of the first to third laser beams. More specifically, regarding the first example, the use efficiency of light for the first laser beam is 71.4%, the use efficiency of light for the second laser beam is 63.4%, and the use efficiency of light for the third laser beam is 60.3%. Regarding the second example, the use efficiency of light for the first laser beam is 83.3%, the use efficiency of light for the second laser beam is 56.6%, and the use efficiency of light for the third laser beam is 56.4%. Regarding the third example, the use efficiency of light for the first laser beam is 86.8%, the use efficiency of light for the second laser beam is 70.9%, and the use efficiency of light for the third laser beam is 69.6%. Regarding the first example, the use efficiency of light for the first laser beam is 70.3%, the use efficiency of light for the second laser beam is 59.1%, and the use efficiency of light for the third laser beam is 68.2%.

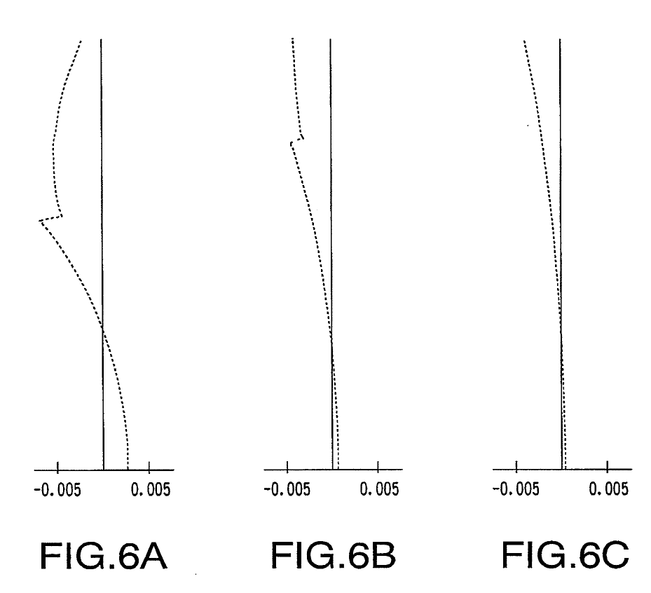

FIG. 6A is a graph illustrating the spherical aberration caused when the first laser beam is used in the optical information recording/reproducing device 100 having the objective optical system 30 according to the first example. FIG. 6B is a graph illustrating the spherical aberration caused when the second laser beam is used in the optical information recording/reproducing device 100 having the objective optical system 30 according to the first example. FIG. 6C is a graph illustrating the spherical aberration caused when the third laser beam is used in the optical information recording/reproducing device 100 having the objective optical system 30 according to the first example.

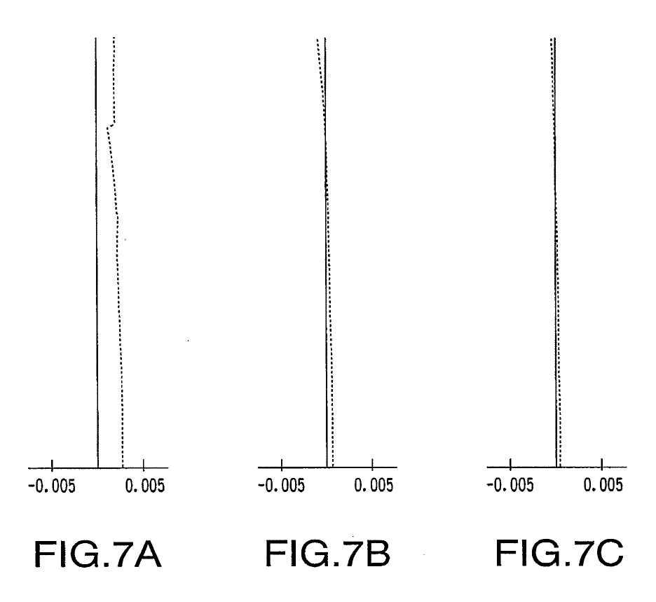

FIG. 7A is a graph illustrating the spherical aberration caused when the first laser beam is used in the optical information recording/reproducing device 100 having the objective optical system 30 according to the second example. FIG. 7B is a graph illustrating the spherical aberration caused when the second laser beam is used in the optical information recording/reproducing device 100 having the objective optical system 30 according to the second example. FIG. 7C is a graph illustrating the spherical aberration caused when the third laser beam is used in the optical information recording/reproducing device 100 having the objective optical system 30 according to the second example.

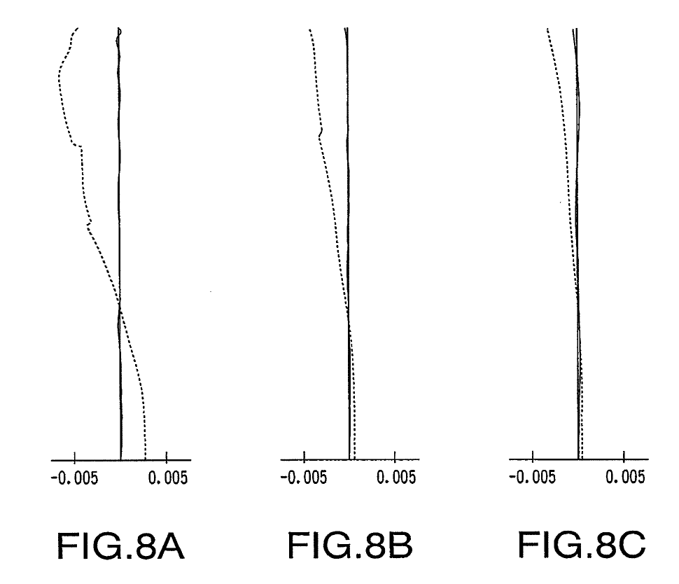

FIG. 8A is a graph illustrating the spherical aberration caused when the first laser beam is used in the optical information recording/reproducing device 100 having the objective optical system 30 according to the third example. FIG. 8B is a graph illustrating the spherical aberration caused when the second laser beam is used in the optical information recording/reproducing device 100 having the objective optical system 30 according to the third example. FIG. 8C is a graph illustrating the spherical aberration caused when the third laser beam is used in the optical information recording/reproducing device 100 having the objective optical system 30 according to the third example.

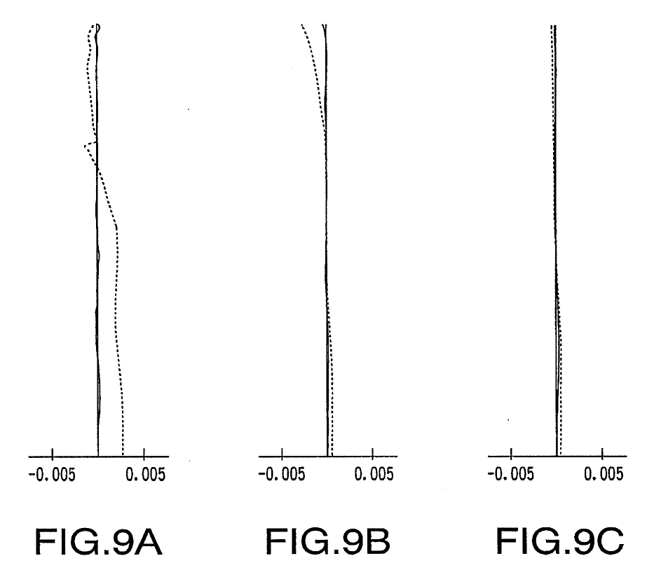

FIG. 9A is a graph illustrating the spherical aberration caused when the first laser beam is used in the optical information recording/reproducing device 100 having the objective optical system 30 according to the fourth example. FIG. 9B is a graph illustrating the spherical aberration caused when the second laser beam is used in the optical information recording/reproducing device 100 having the objective optical system 30 according to the fourth example. FIG. 9C is a graph illustrating the spherical aberration caused when the third laser beam is used in the optical information recording/reproducing device 100 having the objective optical system 30 according to the fourth example.

In each of FIGS. 6A-6C, 7A-7C, 8A-8C, and 9A-9C, a curve indicated by a solid line represents the spherical aberration when the laser beam having the design wavelength (shown in Tables 1, 9, 17, and 25) is incident on the objective optical system 30, and a curve indicated by a dashed line represents the spherical aberration when the wavelength of the laser beam shifts by a 5 nm from the design wavelength.

As can be seen from FIGS. 6A-6C, 7A-7C, 8A-8C, and 9A-9C, each of the first to fourth examples is able to suitably suppress the spherical aberration for all of the optical discs D1-D3 when each of the first to third laser beams is at the design wavelength.

As described above, the optical information recording/reproducing device 100 is able to achieve the compatibility with the optical discs D1-D3 with high accuracy while securing the high use efficiency of light.

As can be seen from FIGS. 7A-7C and FIGS. 9A-9C, each of the second and fourth examples in which the annular zone structure in the first area is formed by combining the three types of optical path difference functions is able to suitably suppress change of the spherical aberration when the wavelength variations occur. As can be seen from FIGS. 8A-8C, the third example having the annular zone structure satisfying the conditions (5), (6), (10) and (11) in the first area is able to suitably suppress change of the spherical aberration when the wavelength variations occur.

Although the present invention has been described in considerable detail with reference to certain preferred embodiments thereof, other embodiments are possible.

In the above described embodiment, the optical element 10 of the objective optical system 30 is made of material having a high degree of dispersion. However, the objective lens 20 may be made of material having a high degree of dispersion if the objective optical system is configured to suitable correct the chromatic aberration caused by employing the material having a high degree of dispersion. Such a configuration for suitably correcting the chromatic aberration is achieved by providing an chromatic aberration correction element configured by cementing together a pair of positive and negative lenses made of materials having different degrees of dispersion, for the objective optical system.

This application claims priority of Japanese Patent Application No. P2007-243467, filed on Sep. 20, 2007. The entire subject matter of the application is incorporated herein by reference.

What is claimed is:

1. An objective optical system used for an optical information recording/reproducing device for recording information to and/or reproducing information from at least three types of optical discs, by selectively using one of three types of substantially collimated light beams including a first light beam having a first wavelength λ₁ (nm), a second light beam having a second wavelength λ₂ (nm) and a third light beam having a third wavelength λ₃ (nm),
the at least three types of optical discs including a first optical disc for which information recording or information reproducing is executed by using the first light beam, a second optical disc for which information recording or information reproducing is executed by using the second light beam, and a third optical disc for which information recording or information reproducing is executed by using the third light beam,
the first, second and third wavelengths λ₁, λ₂ and λ₃ satisfying a condition:
λ₁<λ₂<λ₃,
when protective layer thicknesses of the first, second and third optical discs are represented by t1 (mm), t2 (mm) and t3 (mm), respectively, the protective layer thicknesses satisfying a condition of t1<t2<t3,
when numerical apertures required for information reproducing or information recording on the first, second and third optical discs are defined as NA1, NA2 and NA3, respectively, the numerical apertures satisfying following relationships:
(NA1>NA3); and
(NA2>NA3),
the objective optical system comprising:
an optical element configured to have a phase shift structure on at least one surface of the optical element; and
a single-element objective lens made of resin located between the optical element and an optical disc being used,
the phase shift structure including a plurality of refractive surface zones concentrically formed about a predetermined axis,
the phase shift structure including a first area to contribute to converging at least the third light beam on a record surface of the third optical disc,
the first area including at least two types of steps, each of which is formed at a boundary between adjacent ones of the plurality of refractive surface zones,
the at least two types of steps giving optical path length differences different from each other to an incident light beam,
when m11 represents a diffraction order at which diffraction efficiency for the first light beam given by a first step of the at least two types of steps in the first area is maximized, m21 represents a diffraction order at which diffraction efficiency for the second light beam given by the first step is maximized, m31 represents a diffraction order at which diffraction efficiency for the third light beam given by the first step is maximized, m12 represents a diffraction order at which diffraction efficiency for the first light beam given by a second step of the at least two types of steps in the first area is maximized, n1 represents a refractive index of the optical element with respect to the first light beam, n2 represents a refractive index of the optical element with respect to the second light beam, and n3 represents a refractive index of the optical element with respect to the third light beam, the phase shift structure satisfying following conditions:
0.01<(E21−E11)/E11<0.10 (2);
0.04<(E31−E11)/E11<0.30 (3); and
−100<φ1+φ2<−10 (4),
where E11=m11(λ₁/(n1−1)),
E21=m21(λ₂/(n2−1)),
E31=m31(λ₃/(n3−1)),
φ1=ΣP₁2ih²ⁱ×m11 (unit: λ₁),
φ2=ΣP₂2ih²ⁱ×m12 (unit: λ₁),
P₁2i (i: natural number) represents a 2i-order coefficient of an optical path difference function defining the first step, and P₂2i represents a 2i-order coefficient of an optical path difference function defining the second step.

2. The objective optical system according to claim 1,
wherein the phase shift structure satisfies conditions:
0.015<(E21−E11)/E11<0.055 (5); and
−75<φ1+φ2<−35 (6).

3. The objective optical system according to claim 1,
wherein the optical element is configured such that, with regard to the first light beam, a refracting effect is cancelled by an effect of giving an optical path length difference by the phase shift structure so that the optical element has almost no power with respect to the first light beam,
wherein the optical element has Abbe number νd satisfying a condition:
15<νd<40 (1),
wherein the phase shift structure takes values of m11=10, m21=6 and m31=5.

4. The objective optical system according to claim 1,
wherein:
the phase shift structure includes three types of steps, each of which is formed at a boundary between adjacent ones of the plurality of refractive surface zones;
at least one type of the three types of steps is configured such that a diffraction order at which diffraction efficiency for the first light beam is maximized is a second order, a diffraction order at which diffraction efficiency for the second light beam is maximized is a first order, and a diffraction order at which diffraction efficiency for the third light beam is maximized is a first order.

5. The objective optical system according to claim 1,
wherein
the phase shift structure includes a second area located outside the first area;
the second area is configured to contribute to converging the first and second light beams on record surfaces of the first and second optical discs, respectively, and not to contribute to convergence of the third light beam;
the second area includes a step -formed at a boundary between adjacent ones of the plurality of refractive surface zones, the step in the second area giving at least one type of optical path length difference to an incident light beam;
an absolute value of the at least one type of optical path length difference given by the step in the second area is approximately equal to an odd multiple of the first wavelength of the first light beam.

6. The objective optical system according to claim 5,
wherein the absolute value of the at least one type of optical path length difference given by the step in the second area is approximately equal to 3λ₁.

7. The objective optical system according to claim 5,
wherein the absolute value of the at least one type of optical path length difference given by the step in the second area is approximately equal to 5λ₁.

8. The objective optical system according to claim 5,
wherein:
the phase shift structure includes a third area located outside the second area;
the third area is configured to contribute to converging the first light beam on the record surface of the first optical disc, and not to contribute to convergence of each of the second and third light beams;
the third area includes a step formed at a boundary between adjacent ones of the plurality of refractive surface zones, the step in the third area giving at least one type of optical path length difference to an incident light beam; and
an absolute value of the at least one type of optical path length difference given by the step in the third area is different from absolute values of all types of optical path length differences given by the second area.

9. The objective optical system according to claim 8, wherein the at least one type of optical path length difference given by the step in the third area is approximately equal to 1λ₁.

10. An optical information recording/reproducing device for recording information to and/or reproducing information from at least three types of optical discs, by selectively using one of three types of substantially collimated light beams including a first light beam having a first wavelength λ₁ (nm), a second light beam having a second wavelength λ₂ (nm) and a third light beam having a third wavelength λ₃ (nm),
the at least three types of optical discs including a first optical disc for which information recording or information reproducing is executed by using the first light beam, a second optical disc for which information recording or information reproducing is executed by using the second light beam, and a third optical disc for which information recording or information reproducing is executed by using the third light beam,
the first, second and third wavelengths λ₁, λ₂ and λ₃ satisfying a condition:
λ₁<λ₂<λ₃,
when protective layer thicknesses of the first, second and third optical discs are represented by t1 (mm), t2 (mm) and t3 (mm), respectively, the protective layer thicknesses satisfying condition of t1<t2<t3,
when numerical apertures required for information reproducing or information recording on the first, second and third optical discs are defined as NA1, NA2 and NA3, respectively, the numerical apertures satisfying following relationships:
(NA1>NA3); and
(NA2>NA3),
the optical information recording/reproducing device comprising:
light sources respectively emitting the first to third light beams;
conversion optical components respectively converging the first to third light beams into collimated light beams; and
an objective optical system,
the objective optical system comprising:
an optical element configured to have a phase shift structure on at least one surface of the optical element; and
a single-element objective lens made of resin located between the optical element and an optical disc being used,
the phase shift structure including a plurality of refractive surface zones concentrically formed about a predetermined axis,
the phase shift structure including a first area to contribute to converging at least the third light beam on a record surface of the third optical disc,
the first area including at least two types of steps, each of which is formed at a boundary between adjacent ones of the plurality of refractive surface zones,
the at least two types of steps giving optical path length differences different from each other to an incident light beam,
the protective layer thicknesses of the first to third optical discs being defined as t3−t1≧1.0 mm, and t2≈0.6 mm,
when m11 represents a diffraction order at which diffraction efficiency for the first light beam given by a first step of the at least two types of steps in the first area is maximized, m21 represents a diffraction order at which diffraction efficiency for the second light beam given by the first step is maximized, m31 represents a diffraction order at which diffraction efficiency for the third light beam given by the first step is maximized, m12 represents a diffraction order at which diffraction efficiency for the first light beam given by a second step of the at least two types of steps in the first area is maximized, n1 represents a refractive index of the optical element with respect to the first light beam, n2 represents a refractive index of the optical element with respect to the second light beam, and n3 represents a refractive index of the optical element with respect to the third light beam, the phase shift structure satisfying following conditions:
0.01<(E21−E11)/E11<0.10 (2);
0.04<(E31−E11)/E11<0.30 (3); and
−100<φ1+φ2<−10 (4),
where E11=m11(λ₁/(n1−1)),
E21=m21(λ₂/(n2−1)),
E31=m31(λ₃/(n3−1)),
φ1=ΣP₁2ih²ⁱ×m11 (unit: λ₁),
φ2=ΣP₂2ih²ⁱ×m12 (unit: λ₁),
P₁2i (i: integer) represents a 2i-order coefficient of an optical path difference function defining the first step, and P₂2i represents a 2i-order coefficient of an optical path difference function defining the second step.

11. An objective optical system used for an optical information recording/reproducing device for recording information to and/or reproducing information from at least three types of optical discs, by selectively using one of three types of substantially collimated light beams including a first light beam having a first wavelength λ₁ (nm), a second light beam having a second wavelength λ₂ (nm) and a third light beam having a third wavelength λ₃ (nm),
the at least three types of optical discs including a first optical disc for which information recording or information reproducing is executed by using the first light beam, a second optical disc for which information recording or information reproducing is executed by using the second light beam, and a third optical disc for which information recording or information reproducing is executed by using the third light beam,
the first, second and third wavelengths λ₁, λ₂ and λ₃ satisfying a condition:
λ₁<λ₂<λ₃,
when protective layer thicknesses of the first, second and third optical discs are represented by t1 (mm), t2 (mm) and t3 (mm), respectively, the protective layer thicknesses satisfying a condition of t1 <t2 <t3,
when numerical apertures required for information reproducing or information recording on the first, second and third optical discs are defined as NA1, NA2 and NA3, respectively, the numerical apertures satisfying following relationships:
(NA1>NA3); and
(NA2>NA3),
the objective optical system comprising:
an optical element configured to have a phase shift structure on at least one surface of the optical element; and
a single-element objective lens made of resin located between the optical element and an optical disc being used,
the phase shift structure including a plurality of refractive surface zones concentrically formed about a predetermined axis,
the phase shift structure including a first area to contribute to converging at least the third light beam on a record surface of the third optical disc,
the first area including at least two types of steps, each of which is formed at a boundary between adjacent ones of the plurality of refractive surface zones,
the at least two types of steps giving optical path length differences different from each other to an incident light beam,
the annular zone structure satisfying following conditions:
0.01<(EP21−EP11)/EP11<0.10 (7);
0.04<(EP31−EP11)/EP11<0.30 (8); and
−100<Σ(ΔOPD11/λ₁)+Σ(ΔOPD12/λ₁)<−10 (9),
where EP11=INT((ΔOPD11/λ₁)+0.5)×(λ₂(n1−1)),
EP21=INT((ΔOPD21/λ₂)+0.5)×(λ₂(n1−1)),
EP31=INT((ΔOPD31/λ₃)+0.5)×(λ₃(n1−1)),
ΔOPD11/λ₁ denotes an optical path length difference given by a first step of the at least two types of steps in the first area to the first light beam, ΔOPD21/λ₂ denotes an optical path length difference given by the first step to the second light beam, and ΔOPD31/λ₃ denotes an optical path length difference given by the first step to the third light beam, and ΔOPD12/λ₁ denotes an optical path length difference given by a second step of the at least two types of steps to the first light beam, n1 represents a refractive index of the optical element with respect to the first light beam, n2 represents a refractive index of the optical element with respect to the second light beam, and n3 represents a refractive index of the optical element with respect to the third light beam.

12. The objective optical system according to claim 11,
wherein the phase shift structure satisfies conditions:
0.015<(EP21−EP11)/EP11<0.055 (10); and
−75<Σ(ΔOPD11/λ₁)+Σ(ΔOPD12/λ₁)<−35 (11).

13. The objective optical system according to claim 11,
wherein the optical element is configured such that, with regard to the first light beam, a refracting effect is cancelled by an effect of giving an optical path length difference by the phase shift structure so that the optical element has almost no power with respect to the first light beam,
wherein the optical element has Abbe number νd satisfying a condition:
15<νd<40 (1),
wherein one of the at least two types of steps satisfies a condition:
9.85<|ΔOPD11/λ₁|<10.35 (12).

14. The objective optical system according to claim 11,
wherein:
the phase shift structure includes three types of steps giving optical path length differences to an incident beam, each of the three types of steps being formed at a boundary between adjacent ones of the plurality of refractive surface zones; and
at least one type of the three types of steps gives an optical path length difference, an absolute value of which is approximately equal to 2λ₁ to the first light beam.

15. The objective optical system according to claim 11,
wherein
the phase shift structure includes a second area located outside the first area;
the second area is configured to contribute to converging the first and second light beams on record surfaces of the first and second optical discs, respectively, and not to contribute to convergence of the third light beam;
the second area includes a step formed at a boundary between adjacent ones of the plurality of refractive surface zones, the step in the second area giving at least one type of optical path length difference to an incident light beam; and
an absolute value of the at least one type of optical path length difference given by the step in the second area is approximately equal to an odd multiple of the first wavelength of the first light beam.

16. The objective optical system according to claim 15,
wherein the absolute value of the at least one type of optical path length difference given by the step in the second area is approximately equal to 3λ₁.

17. The objective optical system according to claim 15,
wherein the absolute value of the at least one type of optical path length difference given by the step in the second area is approximately equal to 5λ₁.

18. The objective optical system according to claim 15,
wherein:
the phase shift structure includes a third area located outside the second area;
the third area is configured to contribute to converging the first light beam on the record surface of the first optical disc, and not to contribute to convergence of each of the second and third light beams;
the third area includes a step formed at a boundary between adjacent ones of the plurality of refractive surface zones, the step in the third area giving at least one type of optical path length difference to an incident light beam;
an absolute value of the at least one type of optical path length difference given by the step in the third area is different from absolute values of all types of optical path length differences given by the second area.

19. The objective optical system according to claim 18, wherein the at least one type of optical path length difference given by the step in the third area is approximately equal to 1λ₁.

20. An optical information recording/reproducing device for recording information to and/or reproducing information from at least three types of optical discs, by selectively using one of three types of substantially collimated light beams including a first light beam having a first wavelength λ₁ (nm), a second light beam having a second wavelength λ₂ (nm) and a third light beam having a third wavelength λ₃ (nm),
the at least three types of optical discs including a first optical disc for which information recording or information reproducing is executed by using the first light beam, a second optical disc for which information recording or information reproducing is executed by using the second light beam, and a third optical disc for which information recording or information reproducing is executed by using the third light beam,
the first, second and third wavelengths λ₁, λ₂ and λ₃ satisfying a condition:
λ₁<λ₂<λ₃,
when protective layer thicknesses of the first, second and third optical discs are represented by t1 (mm), t2 (mm) and t3 (mm), respectively, the protective layer thicknesses satisfying a condition of t1<t2<t3,
when numerical apertures required for information reproducing or information recording on the first, second and third optical discs are defined as NA1, NA2 and NA3, respectively, the numerical apertures satisfying following relationships:
(NA1>NA3); and
(NA2>NA3),
the optical information recording/reproducing device comprising:
light sources respectively emitting the first to third light beams;
conversion optical components respectively converging the first to third light beams into collimated light beams; and
an objective optical system,
the objective optical system comprising:
an optical element configured to have a phase shift structure on at least one surface of the optical element; and
a single-element objective lens made of resin located between the optical element and an optical disc being used,
the phase shift structure including a plurality of refractive surface zones concentrically formed about a predetermined axis,
the phase shift structure including a first area to contribute to converging at least the third light beam on a record surface of the third optical disc,
the first area including at least two types of steps, each of which is formed at a boundary between adjacent ones of the plurality of refractive surface zones,
the at least two types of steps giving optical path length differences different from each other to an incident light beam,
the protective layer thicknesses of the first to third optical discs being defined as t3−t1≧1.0 mm, and t2≈0.6 mm,
the annular zone structure satisfying following conditions:
0.01<(EP21−EP11)/EP11<0.10 (7);
0.04<(EP31−EP11)/EP11<0.30 (8); and
−100<Σ(ΔOPD11/λ₁)+Σ(ΔOPD12/λ₁)<−10 (9),
where EP11=INT((ΔOPD11/λ₁)+0.5)×(λ₁(n1−1)),
EP21=INT((ΔOPD21/λ₂)+0.5)×(λ₂(n1−1)),
EP31=INT((ΔOPD31/λ₃)+0.5)×(λ₃(n1−1)),
ΔOPD11/λ₁ denotes an optical path length difference given by a first step of the at least two types of steps in the first area to the first light beam, ΔOPD21/λ₂ denotes an optical path length difference given by the first step to the second light beam, and ΔOPD31/λ₃ denotes an optical path length difference given by the first step to the third light beam, and ΔOPD12/λ₁ denotes an optical path length difference given by a second step of the at least two types of steps to the first light beam, n1 represents a refractive index of the optical element with respect to the first light beam, n2 represents a refractive index of the optical element with respect to the second light beam, and n3 represents a refractive index of the optical element with respect to the third light beam.
